(19) United States
(12) Patent Application Publication
(10) Pub. No.: US 2014/0211132 A1
(43) Pub. Date: Jul. 31, 2014

(54) LIQUID CRYSTAL DISPLAY DEVICE

(71) Applicants: Koichi Miyachi, Osaka-shi (JP); Isamu Miyake, Osaka-shi (JP)

(72) Inventors: Koichi Miyachi, Osaka-shi (JP); Isamu Miyake, Osaka-shi (JP)

(73) Assignee: SHARP KABUSHIKI KAISHA, Osaka-shi, Osaka (JP)

(21) Appl. No.: 14/238,283

(22) PCT Filed: Aug. 7, 2012
(86) PCT No.: PCT/JP2012/070103

§ 371 Date: Feb. 11, 2014

(30) Foreign Application Priority Data
Aug. 12, 2011 (JP) 2011-177298

(51) Int. Cl. G02F 1/1337; G02F 1/1335

(52) U.S. Cl. CPC G02F 1/133788; G02F 1/133528; G02F 1/133711
USPC 349/99; 349/96

(57) ABSTRACT

Provided is a liquid crystal display device provided with light fastness, stabilized alignment of liquid crystal, and excellent display quality. The liquid crystal display device of the present invention is a liquid crystal display device in which at least one of a pair of substrates includes a photo-alignment film, and an electrode in the stated order from the liquid crystal layer side; the photo-alignment film aligns liquid crystal molecules horizontally to the photo-alignment film surface; a polarization transmission axis direction of a polarizing element in the observation surface side of the liquid crystal cell crosses an alignment direction of liquid crystal molecules at a voltage lower than the threshold voltage in the liquid crystal layer; and a material constituting the photo-alignment film contains a material for aligning liquid crystal molecules in a direction crossing a polarization direction of polarized light by polarized light irradiated to the photo-alignment film.

### TECHNICAL FIELD

The present invention relates to a liquid crystal display device. More specifically, the present invention relates to a liquid crystal display device in which a polymer layer for improving a property is formed on an alignment film.

### BACKGROUND ART

A liquid crystal display (LCD) device is a display device that controls the alignment of birefringent liquid crystal molecules to control the transmission/shielding of light (on/off of display). Examples of display modes of LCD include a vertical alignment (VA) mode in which liquid crystal molecules having negative anisotropy of dielectric constant are aligned vertically to a substrate surface; an in-plane switching (IPS) mode and a fringe field switching (FES) mode, in which liquid crystal molecules having positive or negative anisotropy of dielectric constant are aligned horizontally to a substrate surface to apply a horizontal electric field to a liquid crystal layer.

Among these, in a multi-domain vertical alignment (MVA) mode in which liquid crystal molecules having negative anisotropy of dielectric constant are used and a rib or a slit of an electrode is provided as an alignment regulating structure, a liquid crystal alignment direction during voltage application can be controlled in plural directions without subjecting an alignment film to a rubbing treatment, and thus viewing angle characteristic is superior. However, in an MVA-LCD of the related art, an upper side of a rib or an upper side of a slit is the boundary of alignment division of liquid crystal molecules, the transmittance during white display is low, dark lines are observed in the display, and thus there is room for improvement.

Therefore, as a method for obtaining a high-luminance and high-speed response LCD, alignment stabilization techniques using a polymer (hereinafter, also referred to as “polymer sustained (PS) technique”) have been suggested (for example, refer to Patent Literatures 1 to 9). Among these, in pre-tilt angle imparting techniques using a polymer (hereinafter, also referred to as “polymer sustained alignment (PSA) technique”), polymerizable components such as polymerizable monomers and oligomers are mixed to obtain a liquid crystal composition; the liquid crystal composition is sealed between substrates; and the monomers are polymerized to form a polymer in a state where liquid crystal molecules are tilted by applying a voltage between the substrates. As a result, the liquid crystal molecules have a certain pre-tilt angle even after the voltage application is stopped, and thus the alignment direction of the liquid crystal molecules can be regulated to be uniform. The monomers are selected from materials which are polymerizable by heat, light (ultraviolet rays), or the like. In addition, the liquid crystal composition may contain a polymerization initiator for initiating the polymerization of monomers (for example, refer to Patent Literature 4).

Examples of other liquid crystal display elements using a polymerizable monomer include polymer-stabilized ferroelectrics liquid crystal (FLC) phase (for example, refer to Patent Literature 10).

In addition, there are disclosed literatures which are of investigations on the effect of hysteresis or the like on the monomer concentration to be used for the PS treatment in liquid crystal, in a liquid crystal display device in which one substrate is subjected to a photo-alignment treatment and the PS treatment and the other substrate is subjected to a rubbing treatment (for example, refer to Non Patent Literature 1). Further, regarding the liquid crystal photo-alignment technique, particularly, inversion of photo-alignment directions, a method for adjusting a photo-alignment film by using a cinnamate polymer is devised (for example, refer to Non Patent Literatures 2 and 3).

### CITATION LIST

### Patent Literature

Patent Literature 1: Japanese Patent No. 4175826
Patent Literature 2: Japanese Patent No. 4237977
Patent Literature 3: JP-A 2005-181582
Patent Literature 4: JP-A 2004-286984
Patent Literature 5: JP-A 2009-102639
Patent Literature 6: JP-A 2009-132718
Patent Literature 7: JP-A 2010-33093
Patent Literature 8: U.S. Pat. No. 6,177,972
Patent Literature 9: JP-A 2003-177418
Patent Literature 10: JP-A 2007-92000
Non Patent Literature 1: Y. Nagatake, et al., “Hysteresis Reduction in EO Characteristic of Photo-Aligned IPS-LCDs with Polymer—Surface—Stabilized Method”, IDW′10, International Display Workshops, 2010, pp. 89 to 92
Non Patent Literature 2: M. Obi, et al., “Reversion of Photoalignment Direction of Liquid Crystals Induced by Cinnamate Polymer Films”, Japanese Journal of Applied Physics, The Japan Society of Applied Physics, 1999, vol. 38, pp. L145 to L147
Non Patent Literature 3: Kunihiro Ichimura, “Photo-alignment of liquid crystal”, first edition, Yoneda Shuppan, Mar. 7, 2007, pp. 121 to 125

### SUMMARY OF INVENTION

### Technical Problem

The present inventors have made investigations on a photo-alignment technique in which the liquid crystal alignment direction during voltage application can be controlled in plural directions without subjecting an alignment film to a rubbing treatment and thus superior viewing angle characteristic can be obtained. The photo-alignment technique is a technique in which a photoactive material is used to form an alignment film; and the formed film is irradiated with light rays such as ultraviolet rays to impart an alignment regulating force to the alignment film. According to the photo-alignment technique, a film surface can be subjected to an alignment treatment without contact. Therefore, the generation of contaminants, dust and the like can be suppressed during the alignment treatment, and thus the photo-alignment technique can be also applied to a large-sized panel unlike a rubbing treatment.

Further, a liquid crystal display device obtained by photo-alignment treatment is advantageous in terms of high contrast, high resolution, and high yield. In recent years, a horizontal alignment film preferably applicable to the liquid crystal display device of the in-plane switching (IPS) mode, the fringe field switching (FFS) mode, the ferroelectrics liquid crystal (FLC) mode, or an anti-ferroelectrics liquid crystal (AFLC) mode has been actively investigated and developed, and particularly, in a case where a photo-alignment film by photoisomerization is used, horizontal alignment is made possible by low irradiation energy, and thus the photo-alignment technique additionally has advantages that the technique does not deteriorate other members (color filter [CF] or the like) and is excellent in mass productivity.

However, a liquid crystal display device obtained by a photo-alignment treatment has so high sensitivity as to cause reaction with low irradiation energy (for example, 100 mJ/cm or lower) but is susceptible to sunlight or the like. That is, at the time of use of the liquid crystal display device, disorder of the alignment by outside light lowers the display quality.

Additionally, one of problems which a back light unit has is ultraviolet rays from a cold cathode-fluorescent lamp (CCFL), but use of a recent white light emitting diode (LED) instead of CCFL makes light free from ultraviolet rays.

However, it may be possible that ultraviolet rays of sunlight or the like come to the surface side (observation side) and a countermeasure for that is necessary. The above-mentioned literatures do not disclose any preferable means for solving the alignment disorder by the outside light.

The present invention has been made in consideration of such circumstances, and an object thereof is to provide a liquid crystal display device provided with light fastness, and excellent display quality by a polymer layer disposed on a photo-alignment film.

### Solution to Problem

In order to prepare a liquid crystal display device of the IPS mode or the like obtained by using a photo-alignment treatment, the present inventors have focused on prevention of lowering display quality attributed to alignment disorder by outside light as a configuration hard to be affected by sunlight or the like. The present inventors have found that a liquid crystal display device is effective to solve the problem caused by incidence of ultraviolet rays of sunlight or the like by the configuration in which (1) a polarization transmission axis direction of a polarizing element (polarizing plate or the like) crosses a liquid crystal alignment direction and at the same time a material constituting a photo-alignment film aligns liquid crystal molecules in a direction crossing a polarization direction of polarized light irradiated to the photo-alignment film by polarized light irradiated to the photo-alignment film, or (2) a polarization transmission axis direction of a polarizing element is along a liquid crystal alignment direction and at the same time a material constituting a photo-alignment film aligns liquid crystal molecules in a direction along a polarization direction of polarized light irradiated to the photo-alignment film by polarized light irradiated to the photo-alignment film. That is, the present inventors have found that if the arrangement is made as described above, even if sunlight comes in a panel, polarized light which actualizes the original alignment direction is irradiated to the panel and thus alignment disorder is hardly caused.

The present inventors have found that the alignment stability can be further improved because the PS polymerization treatment was carried out by introducing a polymer stabilization (PS) process of adding a polymerizable monomer to liquid crystal and polymerizing the polymerizable monomer with heat or light to form a polymer layer on the interface with a liquid crystal layer.

In addition, as a result of additional thorough investigation, the present inventors have found that the PS reaction can be further promoted by adding a functional group including a multiple bond such as an alkenyl group to a molecular structure of a liquid crystal material. The reason is considered to be as follows. First, a multiple bond of liquid crystal molecules can be activated by light. Second, a liquid crystal material including such a multiple bond can function as a carrier for transferring the activation energy, radicals, and the like. That is, it is considered that, when an undercoat film, which is an alignment film, is formed of a photoactive material and furthermore liquid crystal is photoactive or functions as a carrier for transferring radicals and the like, a polymerization rate of polymerizable monomers and a rate of forming a PS layer are further improved and thus a stable PS layer is formed. As described above, the present inventors have found that the alignment stability can be also significantly improved by selecting a liquid crystal material.

In this way, the present inventors could solve the above-described problems, thereby completing the present invention.

That is, according to a first aspect of the present invention, there is provided a liquid crystal display device including: a liquid crystal cell that includes a pair of substrates and a liquid crystal layer which is interposed between the pair of substrates, wherein at least one of the pair of substrates includes a photo-alignment film, and an electrode in the stated order from the liquid crystal layer side; the photo-alignment film aligns liquid crystal molecules horizontally to the photo-alignment film surface; the liquid crystal display device further includes a polarizing element in the observation surface side of the liquid crystal cell; a polarization transmission axis direction of the polarizing element crosses an alignment direction of liquid crystal molecules at a voltage lower than the threshold voltage in the liquid crystal layer; and a material constituting the photo-alignment film contains a material for aligning liquid crystal molecules in a direction crossing a polarization direction of polarized light irradiated to the photo-alignment film by polarized light irradiated to the photo-alignment film.

In this specification, the photo-alignment film means a polymer film having a property of controlling alignment of liquid crystal by a photo-alignment treatment, and in general, a film subjected to a photo-alignment treatment by polarized light irradiation. The phrase “aligning liquid crystal molecules in a direction crossing a polarization direction of polarized light irradiated to the photo-alignment film” means that the angle between the alignment direction of liquid crystal molecules and the polarization direction of polarized light irradiated to the photo-alignment film is from 80° to 100°. As described above, in this specification, “crossing” means that the angle formed between two directions is from 80° to 100°.

In the first aspect of the present invention, the material constituting the photo-alignment film may be those which contain a material capable of aligning liquid crystal molecules in a direction crossing the polarization direction of polarized light irradiated to the photo-alignment film by polarized light irradiated to the photo-alignment film. The above-mentioned material is preferably at least one selected from a group consisting of, for example, tarphenyl derivatives, naphthalene derivatives, phenanthrene derivatives, tetracene derivatives, spiropyran derivatives, spiroperimidine derivatives, viologen derivatives, diarylethene derivatives, anthraquinone derivatives, azobenzene derivatives, cinnamoyl derivatives, chalcone derivatives, cinnamate derivatives, coumarin derivatives, stilbene derivatives, and anthracene derivatives. A benzene ring contained in these derivatives may be a heterocyclic ring. Herein, “derivatives” means compounds substituted with a specified atom or functional group; and compounds in which a monovalent or divalent or higher functional group is incorporated into a molecular structure of a polymer. A photoactive functional group in these derivatives (hereinafter, also referred to as a photofunctional group) may be present in a molecular structure of amain chain of a polymer or in a molecular structure of a side chain of a polymer; and may be a monomer or an oligomer. The photofunctional group is present more preferably in a molecular structure of amain chain of a polymer or in a molecular structure of a side chain of a polymer; and furthermore preferably in a molecular structure of a side chain of a polymer. In addition, when a monomer or oligomer including such a photofunctional group (preferably, 3% by weight or greater) is contained in the photo-alignment film, a polymer constituting the photo-alignment film may be photoinactive. In terms of heat resistance, the polymer constituting the photo-alignment film is preferably polyvinyl, polyamic acid, polyamide, polyimide, polymaleimide, or polysiloxane. The material constituting the photo-alignment film may be a polymer alone or a mixture containing additional molecules together with a polymer as long as it has the above-mentioned properties. For example, a low-molecular-weight compound such as an additive or a photoinactive polymer may further be added to a polymer including a photoalignable functional group. For example, an additive including a photoalignable functional group may be added to a photoinactive polymer.

The material constituting the photo-alignment film is selected from materials which cause photodissociation, Norrish reaction for generating radicals, photoisomerization, or photodimerization. The material constituting the photo-alignment film is preferably materials including a photoisomerizable functional group and/or a photodimerizable functional group. The photoisomerizable functional group and/or the photodimerizable functional group are preferable to include at least one kind selected from a group consisting of a cinnamate group, an azo group, a chalcone group, a stilbene group, and a coumarin group. Accordingly, the liquid crystal is provided with high reliability without elution of photodissociated products and an alignment treatment with low irradiation energy is made possible. Especially, a photoisomerizable functional group (photoisomerizable group) is preferable, and the material constituting the photo-alignment film is preferable to include a photoisomerizable group, and the photoisomerizable group is preferable to include at least one kind selected from a group consisting of, for example, a cinnamate group, an azo group, a chalcone group, and a stilbene group. A cinnamate group, a chalcone group, and a stilbene group all cause photoisomerization and photodimerization, and both photoisomerization and photodimerization affect photo-alignment, and thus the above-mentioned functional group is more preferable to include at least one kind selected from a group consisting of a cinnamate group, a chalcone group, and a stilbene group. Particularly preferable one is a cinnamate group.

The photoisomerizable functional group (photoisomerizable group) has the advantageous point as described above that it makes an alignment treatment with low irradiation energy possible (improvement of the productivity, lessening damages on other members, etc.). However, the photoisomerization itself, which is a photoreaction mechanism, is reversible, and thus in the case of using particularly a photoisomerizable group, it is indispensable to take measures against incidence of ultraviolet rays of sunlight or the like from the outside. The liquid crystal display device of the present invention is particularly suitable in a case where the photo-alignment film includes a photoisomerizable group since the serious problem of ultraviolet rays particular in such a photoisomerizable group can be solved sufficiently and the peculiar advantages of the photoisomerizable group as described above can be provided.

In a second aspect of the present invention, there is provided a liquid crystal display device including: a liquid crystal cell that includes a pair of substrates and a liquid crystal layer which is interposed between the pair of substrates, wherein at least one of the pair of substrates includes a photo-alignment film, and an electrode in the stated order from the liquid crystal layer side; the photo-alignment film aligns liquid crystal molecules horizontally to the photo-alignment film surface; the liquid crystal display device further includes a polarizing element in the observation surface side of the liquid crystal cell; a polarization transmission axis direction of the polarizing element crosses an alignment direction of liquid crystal molecules at a voltage lower than the threshold voltage in the liquid crystal layer; and a material constituting the photo-alignment film contains a polymer including a molecular structure represented by the following formula (1).

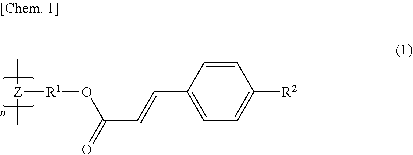

(In the formula, Z represents a polyvinyl monomer unit, a polyamic acid monomer unit, a polyamide monomer unit, a polyimide monomer unit, a polymaleimide monomer unit, or a polysiloxane monomer unit; R¹ represents a single bond or a divalent organic group; R² represents a hydrogen atom, a fluorine atom, or a monovalent organic group; and n represents an integer of 2 or greater and more preferably 8 or greater.) The above-mentioned polymer may be a copolymer of a repeating unit represented by the formula (1) and a unit other than the repeating unit as long as the effects of the present invention is exhibited, but it is preferable to contain the repeating unit represented by the formula (1) in an amount of 25% by mole or greater in all monomer units.

Z is particularly preferable to represent a polyvinyl monomer unit containing 2 to 8 carbon atoms. The divalent organic group (spacer group) in R¹ is preferable to contain at least one kind selected from a group consisting of, for example, an alkylene group, an ether group, and an ester group. The alkylene group is more preferable to contain 8 or lower carbon atoms. The alkylene group is further preferably a methylene group. R¹ is particularly preferably a single bond. The monovalent organic group in R² is preferable to contain at least one kind selected from a group consisting of an alkyl group, a phenyl group, a fluorine atom, a carbonyl group, an ether group, and an ester group. The alkyl group or phenyl group may be substituted with a fluorine atom or the like. The alkyl group is preferable to contain 8 or lower carbon atoms. R² is particularly preferably a hydrogen atom. Specifically, the material constituting the photo-alignment film is particularly preferable to contain a polymer including a molecular structure (a repeating unit) represented by the following formula (2).

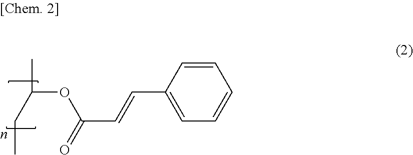

(In the formula, n represents an integer of 2 or greater and more preferably 8 or greater.) It is preferable as other groups for R² that R² is fluorine, or R² is a monovalent organic group which may be modified with an alkyl group, an alkoxy group, a benzyl group, a phenoxy group, a benzoyl group, a benzoate group, or a benzoyloxy group or their derivatives. In other words, the monovalent organic group is preferably an alkyl group, an alkoxy group, a benzyl group, a phenoxy group, a benzoyl group, a benzoate group, a benzoyloxy group or their derivatives. Consequently, the electric properties and alignment stability can be improved.

In the first aspect and second aspect of the present invention, the material constituting the photo-alignment film is preferable to contain a material for aligning liquid crystal molecules in a direction perpendicular to the polarization direction of polarized light irradiated to the photo-alignment film by polarized light irradiated to the photo-alignment film. “Perpendicular” in this specification may be perpendicular in a plane view of a substrate main surface in the technical field of the present invention, and includes a substantially perpendicular state. The polymer in the second aspect of the present invention specifically includes specified materials suitable for aligning liquid crystal molecules in the direction perpendicular to the polarization direction of polarized light irradiated to the photo-alignment film by polarized light irradiated to the photo-alignment film.

The “threshold voltage” means a voltage value for generating an electric field in which a liquid crystal layer causes optical change and a display state is changed in a liquid crystal display device in this specification. For example, it means a voltage value to give 5% transmittance when the transmittance in the light state is set to 100%.

In the first aspect and second aspect of the present invention, the polarization transmission axis direction of the polarizing element is preferably perpendicular to the alignment direction of liquid crystal molecules at a voltage lower than the threshold voltage in the liquid crystal layer.

In a third aspect of the present invention, there is provided a liquid crystal display device including: a liquid crystal cell that includes a pair of substrates and a liquid crystal layer which is interposed between the pair of substrates, wherein at least one of the pair of substrates includes a photo-alignment film, and an electrode in the stated order from the liquid crystal layer side; the photo-alignment film aligns liquid crystal molecules horizontally to the photo-alignment film surface; the liquid crystal display device further includes a polarizing element in the observation surface side of the liquid crystal cell; a polarization transmission axis direction of the polarizing element is along an alignment direction of liquid crystal molecules at a voltage lower than the threshold voltage in the liquid crystal layer; and a material constituting the photo-alignment film contains a material for aligning liquid crystal molecules in a direction along a polarization direction of polarized light irradiated to the photo-alignment film by polarized light irradiated to the photo-alignment film.

In the third aspect of the present invention, the material constituting the photo-alignment film may be those which contain a material for aligning liquid crystal molecules in the direction along the polarization direction of polarized light irradiated to the photo-alignment film by polarized light irradiated to the photo-alignment film, and except for this, preferable characteristics are similar to those described above in the first aspect of the present invention although concrete compounds are different. For example, also in the third aspect of the present invention, the material (photo-alignment film) constituting the photo-alignment film is preferable to include a photoisomerizable group and the photoisomerizable group is preferable to include at least one kind selected from a group consisting of a cinnamate group, an azo group, a chalcone group, and a stilbene group.

The phrase “a polarization transmission axis direction of the polarizing element is along an alignment direction of liquid crystal molecules at a voltage lower than the threshold voltage in the liquid crystal layer” means the angle formed between the polarization transmission axis direction of the polarizing element and the alignment direction of liquid crystal molecules at a voltage lower than the threshold voltage in the liquid crystal layer is within ±10°. As described above, “along” in this specification means the angle formed between the two directions is within ±10°.

In a fourth aspect of the present invention, there is provided a liquid crystal display device including: a liquid crystal cell that includes a pair of substrates and a liquid crystal layer which is interposed between the pair of substrates, wherein at least one of the pair of substrates includes a photo-alignment film, and an electrode in the stated order from the liquid crystal layer side; the photo-alignment film aligns liquid crystal molecules horizontally to the photo-alignment film surface; the liquid crystal display device further includes a polarizing element in the observation surface side of the liquid crystal cell; a polarization transmission axis direction of the polarizing element is along an alignment direction of liquid crystal molecules at a voltage lower than the threshold voltage in the liquid crystal layer; and a material constituting the photo-alignment film contains a polymer including a molecular structure represented by the following formula (3).

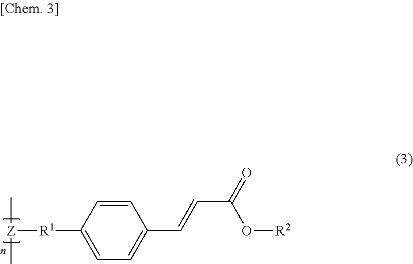

(In the formula, Z represents a polyvinyl monomer unit, a polyamic acid monomer unit, a polyamide monomer unit, a polyimide monomer unit, a polymaleimide monomer unit, or a polysiloxane monomer unit; R¹ represents a single bond or a divalent organic group; R² represents a hydrogen atom or a monovalent organic group; and n represents an integer of 2 or greater and more preferably 8 or greater.) The above-mentioned polymer may be a copolymer of a repeating unit represented by the formula (3) and a unit other than the repeating unit as long as the effects of the present invention is exhibited, but it is preferable to contain the repeating unit represented by the formula (3) in an amount of 25% by mole or greater in all monomer units.

Z is particularly preferable to represent a polyvinyl monomer unit containing 2 to 8 carbon atoms. R¹ is preferable to contain at least one kind selected from a group consisting of, for example, an alkylene group, an ether group, and an ester group. For example, those containing an ester group and an ether group; and the like are preferable. R¹ is preferable to contain 2 or greater carbon atoms. R¹ is preferable to contain 8 or lower carbon atoms. The monovalent organic group in R² is preferable to contain at least one kind selected from a group consisting of an alkyl group, a fluorine atom, an ether group, and an ester group. The alkyl group may be substituted with a fluorine atom or the like. The alkyl group is preferable to contain 8 or lower carbon atoms. R² is particularly preferably a methyl group. n is preferably 24 or lower. Specifically, the material constituting the photo-alignment film is particularly preferable to contain a polymer including a molecular structure (a repeating unit) represented by the following formula (4).

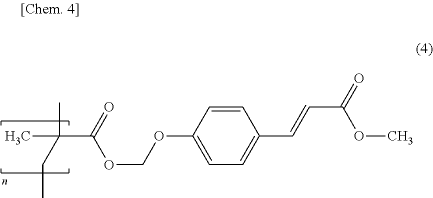

(In the formula, n represents an integer of 2 or greater and more preferably 8 or greater.)

In the third aspect and fourth aspect of the present invention, the material constituting the photo-alignment film is preferable to contain a material for aligning liquid crystal molecules in a direction parallel to the polarization direction of polarized light irradiated to the photo-alignment film by the polarized light irradiated to the photo-alignment film. “Parallel” in this specification may be sufficient to be parallel in a plane view of a substrate main surface in the technical field of the present invention, and includes a substantially parallel state. The polymer in the fourth aspect of the present invention specifically includes specified materials suitable for aligning liquid crystal molecules in the direction parallel to the polarization direction of polarized light irradiated to the photo-alignment film by polarized light irradiated to the photo-alignment film.

In the third aspect and fourth aspect of the present invention, the polarization transmission axis direction of the polarizing element in the observation surface side (front side) of the liquid crystal cell is preferably parallel to the alignment direction of liquid crystal molecules at a voltage lower than the threshold voltage in the liquid crystal layer.

FIG. 18 is a view schematically illustrating a relation of a polarization direction of photo-alignment exposure and a liquid crystal alignment direction in a first aspect and a second aspect of the present invention. FIG. 19 is a view schematically illustrating a relation of a polarization transmission axis direction of a front polarizing plate and a liquid crystal alignment direction in a first aspect and a second aspect of the present invention. FIG. 20 is a view schematically illustrating a relation of a polarization direction of photo-alignment exposure and a liquid crystal alignment direction in a third aspect and a fourth aspect of the present invention. FIG. 21 is a view schematically illustrating a relation of a polarization transmission axis direction of a front polarizing plate and a liquid crystal alignment direction in a third aspect and a fourth aspect of the present invention. The polarization direction of the photo-alignment exposure means, for example, the polarization direction of UV (ultraviolet rays) to be irradiated. Depending on the properties of an alignment film, the alignment direction of liquid crystal may be perpendicular or parallel to the polarization direction of UV to be irradiated, and in the first aspect and second aspect of the present invention as well as in the third aspect and fourth aspect of the present invention, their configurations are coincident in the point that the polarization transmission axis direction of a front polarizing plate (a polarizing plate in the observer side) and the polarization direction of UV to be irradiated are along with each other. It can be said that both have at least technical significances of the present invention in a common or closely relevant manner, and thus have the same or corresponding special technical characteristics in the point that even if sunlight comes in a panel, polarized light which actualizes the original alignment direction is irradiated to the panel, and thus both are excellent in that the liquid crystal alignment is not disordered by the outside light (in terms of light fastness).

Hereinafter, the common characteristics in the first aspect to fourth aspect of the present invention and their preferable characteristics will be described in detail. That is, the following characteristics can be applied preferably to all of the above-mentioned first aspect to fourth aspect of the present invention.

At least one of the pair of substrates includes a photo-alignment film, and an electrode in the stated order from the liquid crystal layer side.

In the liquid crystal display device of the present invention, at least one of the pair of substrates is preferable to include further a polymer layer in the liquid crystal layer side of the photo-alignment film. It is more preferable that both of the pair of substrates further include a polymer layer in the liquid crystal layer side of the photo-alignment film, respectively. The alignment of the photo-alignment film in the present invention is fixed by formation of the polymer layer even if a photo-alignment film inferior in the light fastness is formed, and thus the effect of incidence of ultraviolet rays or the like of sunlight or the like to the liquid crystal layer from the front side after the manufacturing process can be further suppressed, and the stability of a liquid crystal display device can be improved. Further, the light irradiation energy for photo-alignment can be suppressed to the minimum, and thus the range of choice for the manufacturing process such as reduction of the number of light irradiation apparatuses for photo-alignment, productivity improvement, etc. can be widened. The alignment is stabilized by the present invention, and thus the flexibility of the pixel design and the design of a polarizing element is also widened. In addition, the light wavelength for photo-alignment is generally short wavelength, but the light irradiation energy for the photo-alignment can be suppressed to the minimum by the present invention, and thus the photodeterioration of an organic material included in a liquid crystal panel such as a color filter can be suppressed to the minimum. The degree of pre-tilt angle which is imparted to liquid crystal molecules by the photo-alignment film can be adjusted by the kind of light, the irradiation time of light, the irradiation intensity of light, the kind of a photofunctional group, or the like.

The polymer layer is preferably a polymerized product of a monomer contained in the liquid crystal layer. The polymer layer is also preferably a polymerized product of a monomer mixed with a material constituting the photo-alignment film and/or a polymerized product of a monomer applied to the photo-alignment film.

The polymer layer is generally controls the alignment of liquid crystal molecules adjacent to the polymer layer. A polymerizable functional group of the monomer is preferable to contain at least one kind selected from a group consisting of an acrylate group, a methacrylate group, a vinyl group, a vinyloxy group, and an epoxy group. The monomer is preferably a monomer which starts polymerization (photopolymerization) by light irradiation or a monomer which starts polymerization (thermal polymerization) by heating. That is, the polymer layer is preferable to be formed by photopolymerization or to be formed by thermal polymerization. Especially, the polymer layer is preferably a photopolymerized product (PS layer). Accordingly, the polymerization can be easily initiated at normal temperature. The light used for the photopolymerization is preferably either or both of ultraviolet rays and visible light.

In the present invention, the type of polymerization for forming the PS layer is not particularly limited, and examples thereof include “step-growth polymerization” in which bifunctional monomers are polymerized stepwise while forming a new bond; and “chain polymerization” in which monomers are sequentially bonded to active species generated from a small amount of catalyst (an initiator) and are grown in a chain reaction. Examples of the step-growth polymerization include polycondensation and polyaddition. Examples of the chain polymerization include radical polymerization and ionic polymerization (for example, anionic polymerization and cationic polymerization).

The polymer layer can be formed on a photo-alignment film to improve the alignment regulating force of the alignment film. As a result, image sticking in display is significantly reduced and thus display quality can be significantly improved. In addition, when monomers are polymerized to form a polymer layer in a state where liquid crystal molecules are aligned at a pre-tilt angle by applying a threshold or higher voltage to a liquid crystal layer, the polymer layer are formed to include a structure in which liquid crystal molecules are aligned at a pre-tilt angle.

The photo-alignment film is for aligning liquid crystal molecules horizontally to the substrate main surface (photo-alignment film surface), and in the technical field of the present invention, the photo-alignment film may be so-called a horizontal alignment film in which liquid crystal molecules are substantially horizontally aligned. Alternatively, the photo-alignment film may be a film in which adjacent liquid crystal molecules are aligned in this way by a voltage lower than the threshold voltage. The photo-alignment can be realized by irradiating an alignment film with polarized light.

It is preferable that both of the pair of substrates include a photo-alignment film in the liquid crystal layer side, respectively. An alignment treatment means for carrying out alignment treatment is a photo-alignment treatment. The photo-alignment treatment can give excellent viewing angle characteristic.

The photo-alignment film is generally formed of a photoactive material. For example, use of a photoactive material makes an alignment film component excite and generates the transfer of excitation energy and radical for a monomer in the case of photopolymerization of the monomer, and thus the reactivity for PS layer formation can be improved. Further, irradiation with light in a certain condition can perform a photo-alignment treatment for providing alignment properties. When the photoactive material is irradiated with light, the transfer of the excitation energy from the monomer to the alignment film is more effectively performed in a horizontal alignment film rather than in a vertical alignment film, and thus the photo-alignment film can form a more stable PS layer.

The photo-alignment film is preferably a film subjected to the photo-alignment treatment by irradiation with polarized light. The photo-alignment film is more preferably a photo-alignment film subjected to the photo-alignment treatment by irradiation with polarized ultraviolet rays from the outside of the liquid crystal cell. In this case, when the polymer layer is formed by photopolymerization, the photo-alignment film and the polymer layer are preferable to be formed simultaneously by using the same light. Accordingly, a liquid crystal display device is obtained with high production efficiency.

The electrode is preferably a transparent electrode. As an electrode material in the present invention, all of light shielding materials such as aluminum and translucent materials such as indium tin oxide (ITO) and indium zinc oxide (IZO) can be used, and for example, when one of the pair of substrates includes a color filter, it is necessary that the irradiation with ultraviolet rays for polymerizing the monomer be performed on the other substrate not including a color filter, and in such as case, if the electrode is a transparent electrode, the polymerization of the monomer can be carried out efficiently.

An alignment mode of the liquid crystal layer is not particularly limited, and preferably an alignment mode applicable for a horizontal alignment film, and for example, the IPS (in-plane switching) mode, the FFS (fringe field switching) mode, the FLC (ferroelectrics liquid crystal) mode, or the AFLC (anti-ferroelectrics liquid crystal) mode is preferable. As described above, those to which the horizontal photo-alignment film is preferably applicable are desirable to exhibit the effects of the present invention. The IPS mode or the FFS mode is more preferable. Accordingly, the effects of the present invention can be exhibited sufficiently. The alignment mode of the liquid crystal layer is more preferably the IPS mode or the FFS mode.

For example, the FFS mode is preferable. In the FFS mode, a plate-like electrode is provided in addition to a combtooth electrode. Therefore, for example, when substrates are bonded by using an electrostatic chuck for holding a large size substrate, the plate-like electrode can be used as a blocking wall for preventing a high voltage from being applied to a liquid crystal layer, and thus the efficiency in the manufacturing process is particularly superior.

The pair of substrates in the present invention is used for interposing a liquid crystal layer therebetween. Each substrate is formed by, for example, using an insulating substrate made of glass, a resin, or the like as a base and forming wiring, electrodes, color filters, and the like on the insulating substrate.

In one aspect of the present invention, there is provided a liquid crystal display device including: a liquid crystal cell that includes a pair of substrates and a liquid crystal layer which is interposed between the pair of substrates, wherein at least one of the pair of substrates includes a polymer layer, a photo-alignment film, and an electrode in the stated order from the liquid crystal layer side; the polymer layer is a polymerized product of a monomer mixed with a material constituting the photo-alignment film and/or a polymerized product of a monomer applied to the photo-alignment film.

It is preferable to combine the configuration of the liquid crystal display device according to the one aspect of the present invention with the first aspect to fourth aspect of the present invention and the preferable configurations of the first aspect to fourth aspect as described above. For example, in the liquid crystal display device according to the one aspect of the present invention, preferably, the photo-alignment film is for aligning liquid crystal molecules horizontally to the photo-alignment film surface; the liquid crystal display device further includes a polarizing element in the observation surface side of the liquid crystal cell; the polarization transmission axis direction of the polarizing element crosses the alignment direction of the liquid crystal molecules at a voltage lower than the threshold voltage in the liquid crystal layer; and the material constituting the photo-alignment film contains a material for aligning liquid crystal molecules in a direction crossing the polarization direction of polarized light irradiated to the photo-alignment film by polarized light irradiated to the photo-alignment film.

Also in the liquid crystal display device according to the one aspect of the present invention, preferably, the photo-alignment film is for aligning liquid crystal molecules horizontally to the photo-alignment film surface; the liquid crystal display device further includes a polarizing element in the observation surface side of the liquid crystal cell; the polarization transmission axis direction of the polarizing element crosses the alignment direction of the liquid crystal molecules at a voltage lower than the threshold voltage in the liquid crystal layer; and the material constituting the photo-alignment film contains a polymer including a molecular structure represented by the formula (1) above (in the formula, Z represents a polyvinyl monomer unit, a polyamic acid monomer unit, a polyamide monomer unit, a polyimide monomer unit, a polymaleimide monomer unit, or a polysiloxane monomer unit; R¹ represents a single bond or a divalent organic group; R² represents a hydrogen atom, a fluorine atom, or a monovalent organic group; and n represents an integer of 2 or greater and more preferably 8 or greater.).

In the liquid crystal display device according to the one aspect of the present invention, preferably, the photo-alignment film is for aligning liquid crystal molecules horizontally to the photo-alignment film surface; the liquid crystal display device further includes a polarizing element in the observation surface side of the liquid crystal cell; the polarization transmission axis direction of the polarizing element is along the alignment direction of the liquid crystal molecules at a voltage lower than the threshold voltage in the liquid crystal layer; and the material constituting the photo-alignment film contains a material for aligning liquid crystal molecules in a direction along the polarization direction of polarized light irradiated to the photo-alignment film by polarized light irradiated to the photo-alignment film.

In the liquid crystal display device according to the one aspect of the present invention, preferably, the photo-alignment film is for aligning liquid crystal molecules horizontally to the photo-alignment film surface; the liquid crystal display device further includes a polarizing element in the observation surface side of the liquid crystal cell; the polarization transmission axis direction of the polarizing element is along the alignment direction of liquid crystal molecules at a voltage lower than the threshold voltage in the liquid crystal layer; and the material constituting the photo-alignment film contains a polymer including a molecular structure represented by the formula (3) above (in the formula, Z represents a polyvinyl monomer unit, a polyamic acid monomer unit, a polyamide monomer unit, a polyimide monomer unit, a polymaleimide monomer unit, or a polysiloxane monomer unit; R¹ represents a single bond or a divalent organic group; R² represents a hydrogen atom or a monovalent organic group; and n represents an integer of 2 or greater and more preferably 8 or greater.).

The configuration of the liquid crystal display device of the present invention is not especially limited by other components as long as it essentially includes such components. Other configurations (for example, a light source or the like) used commonly for a liquid crystal display device may be applied properly.

The aforementioned modes may be employed in appropriate combination as long as the combination is not beyond the spirit of the present invention.

### Advantageous Effects of Invention

The present invention provides a liquid crystal display device provided with light fastness, stabilized alignment of liquid crystal, and excellent display quality.

### BRIEF DESCRIPTION OF DRAWINGS

FIG. 1 is a perspective view schematically illustrating a liquid crystal display device according to Embodiment 1 at a voltage lower than the threshold voltage.

FIG. 2 is a cross-sectional view schematically illustrating a liquid crystal display device according to Embodiment 1.

FIG. 3 is a plan view schematically illustrating a light irradiation polarization direction, combteeth electrodes, and a liquid crystal alignment direction in a liquid crystal display device according to Embodiment 1.

FIG. 4 is a plan view schematically illustrating a light irradiation polarization direction, combteeth electrodes, and a liquid crystal alignment direction in a liquid crystal display device according to Embodiment 1 in a case where a liquid crystal material having positive anisotropy of dielectric constant is used.

FIG. 5 is a perspective view schematically illustrating a liquid crystal display device according to a modified example of Embodiment 1 at a voltage lower than the threshold voltage.

FIG. 6 is a plan view schematically illustrating a light irradiation polarization direction, combteeth electrodes, and a liquid crystal alignment direction in a liquid crystal display device according to the modified example of Embodiment 1.

FIG. 7 is a plan view schematically illustrating a light irradiation polarization direction, combteeth electrodes, and a liquid crystal alignment direction in a liquid crystal display device according to the modified example of Embodiment 1 in a case where a liquid crystal material having positive anisotropy of dielectric constant is used.

FIG. 8 is a cross-sectional view schematically illustrating a liquid crystal display device according to Embodiment 2.

FIG. 9 is a cross-sectional view schematically illustrating a liquid crystal display device according to Embodiment 3.

FIG. 10 is a plan view schematically illustrating pixels of a liquid crystal display device according to Embodiment 3.

FIG. 11 is a perspective view schematically illustrating a liquid crystal display device according to Comparative Example 1 at a voltage lower than the threshold voltage.

FIG. 12 is a diagram schematically illustrating a state of image sticking in a liquid crystal cell of an IPS mode which is prepared by the present inventors performing a photo-alignment treatment.

FIG. 13 is a diagram schematically illustrating a state of image sticking in a liquid crystal cell of an IPS mode which is prepared by the present inventors introducing a photo-alignment treatment and adopting the PS process.

FIG. 14 is a diagram schematically illustrating a polymerization state of a polymerizable monomer when an alignment film formed of a photoinactive material is subjected to the PS process.

FIG. 15 is a diagram schematically illustrating a polymerization state of a polymerizable monomer when an alignment film formed of a photoactive material is subjected to the PS process.

FIG. 16 is a diagram schematically illustrating a state of a vertical alignment film when polymerizable monomers are polymerized.

FIG. 17 is a diagram schematically illustrating a state of a horizontal alignment film when polymerizable monomers are polymerized.

FIG. 18 is a view schematically illustrating a relation of a polarization direction of photo-alignment exposure and a liquid crystal alignment direction in a first aspect and a second aspect of the present invention.

FIG. 19 is a view schematically illustrating a relation of a polarization transmission axis direction of a front polarizing plate and a liquid crystal alignment direction in a first aspect and a second aspect of the present invention.

FIG. 20 is a view schematically illustrating a relation of a polarization direction of photo-alignment exposure and a liquid crystal alignment direction in a third aspect and a fourth aspect of the present invention.

FIG. 21 is a view schematically illustrating a relation of a polarization transmission axis direction of a front polarizing plate and a liquid crystal alignment direction in a third aspect and a fourth aspect of the present invention.

### DESCRIPTION OF EMBODIMENTS

The present invention will be mentioned in more detail referring to the drawings in the following embodiments, but is not limited to these embodiments. In this specification, a planar electrode means a plate-like electrode including no alignment regulating structure. Additionally, in the respective embodiments, unless otherwise specified, the same symbols are given to the members and portions having similar functions, except that one hundred's place is changed or “′” is added. In this specification, “or greater” and “or lower” respectively include the numeral value itself. That is, “or greater” means “not lower than” (the numeral value and greater than the numeral value).

### Embodiment 1

Embodiment 1 is a liquid crystal display device in which the polarization transmission axis direction of a polarizing plate in the front side (observation surface side) is perpendicular to the liquid crystal alignment direction (initial alignment). The IPS mode is used as the display mode. FIG. 1 is a perspective view schematically illustrating a liquid crystal display device according to Embodiment 1 at a voltage lower than the threshold voltage. In the liquid crystal display device according to Embodiment 1, an array substrate 10, a liquid crystal layer 30, and a color filter substrate 20 are laminated in the stated order from a back surface side to an observation surface side of the liquid crystal display device to form a liquid crystal cell. A rear side polarizing plate 18 and a front side polarizing plate 28 are provided in the back surface side of the array substrate 10 and in the observation surface side of the color filter substrate 20, respectively.

In FIG. 1, the polarization transmission axis direction of the front side polarizing plate 28 is shown by the line in the transverse direction. In addition, the polarization transmission axis direction of the rear side polarizing plate 18 is shown in a similar manner by the line, and the same shall apply to a polarizing plate in the drawings described below. As illustrated in FIG. 1, the polarization transmission axis direction of the front side polarizing plate 28 is arranged to be perpendicular to the alignment direction (liquid crystal major axis direction) of liquid crystal molecules 32 at a voltage lower than the threshold voltage. Further, the respective polarizing plates are arranged in such a manner that the polarization transmission axis direction of the front side polarizing plate 28 is perpendicular to the polarization transmission axis direction of the rear side (opposite side of the observation surface side) polarizing plate 18. In Embodiment 1, the front side polarizing plate 28 and the rear side polarizing plate 18 are respectively linear polarizing plates, and for widening view angle, a retarder may be further provided as a polarizing element. In FIG. 1, the major axis direction of an oval schematically illustrating the liquid crystal molecules 32 shows the major axis direction of rod-like liquid crystal molecules. The same shall apply to the drawings described below.

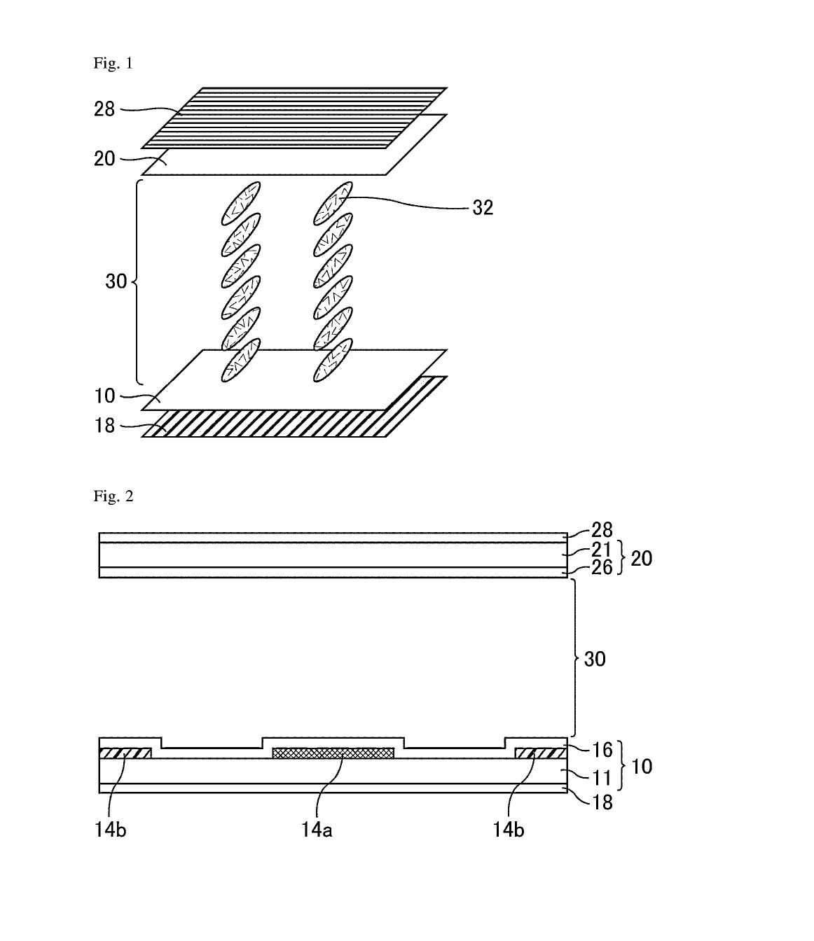

Hereinafter, the liquid crystal display device according to Embodiment 1 will be described in detail. FIG. 2 is a cross-sectional view schematically illustrating a liquid crystal display device according to Embodiment 1. The array substrate 10 includes an insulating transparent substrate 11 made of a material such as glass and also includes various wirings, a pixel electrode 14a, a common electrode 14b, a TFT element, and the like formed on the transparent substrate 11.

Herein, a material for the TFT element is not particularly limited if the material is used commonly, and use of an oxide semiconductor such as IGZO (indium-gallium-zinc-oxide) with high mobility for the TFT element makes the TFT element smaller than a TFT element obtained by using amorphous silicon. Consequently, it is suitable for a high-resolution liquid crystal display, and thus it is a technique having been drawing attention recently. On the other hand, in the case of applying rubbing process for such a display, uniform rubbing in a high-resolution pixel is difficult since the pile density of a rubbing cloth is limited, and there is a concern of inferiority of display quality. In this point, it can be said that a photo-alignment technique excellent in uniform alignment is useful for actual application of an oxide semiconductor such as IGZO.

However, on the other hand, in the case of an oxide semiconductor such as IGZO, there is a concern of shift of semiconductor threshold properties by ultraviolet ray irradiation for photo-alignment. This shift of properties results in change of the TFT element properties of a pixel and affects the display quality. Further, an oxide semiconductor with high mobility more significantly affects also a monolithic driver element formable on a substrate. Therefore, it can be said that the technique according to the present invention which is capable of minimizing the irradiation amount of ultraviolet rays with short wavelength necessary for photo-alignment is useful particularly for actual application of an oxide semiconductor such as IGZO. That is, the liquid crystal display device according to the present invention is particularly suitable in the case of using a TFT element obtained by using IGZO.

Further, the array substrate 10 includes a photo-alignment film 16 in the liquid crystal layer 30 side of the transparent substrate 11, and the color filter substrate 20 also includes a photo-alignment film 26 in the liquid crystal layer 30 side. The photo-alignment films 16 and 26 are films containing polyvinyl, polyamic acid, polyamide, polyimide, polymaleimide, polysiloxane and the like as a main component and subjected to a photo-alignment treatment by irradiation with polarized light as described below. Formation of the photo-alignment film can align liquid crystal molecules in a certain direction. The liquid crystal composition may contain a polymerization initiator if necessary.

The color filter substrate 20 includes an insulating transparent substrate 21 made of a material such as glass, as well as a color filter, a black matrix, or the like formed on the transparent substrate 21. For example, in the case of the IPS mode as Embodiment 1, an electrode is formed only on the array substrate 10, but in the case of other modes, an electrode is formed on both of the array substrate 10 and the color filter substrate 20 if necessary.

The liquid crystal display device according to Embodiment 1 is a transmissive type liquid crystal display device, and a white LED is used as the back light, but either a reflective type or a transflective type may be used. Even in the case of a transflective type, the liquid crystal display device of Embodiment 1 includes a back light. The back light is arranged on the back surface side of the liquid crystal cell such that light passes through the array substrate 10, the liquid crystal layer 30, and the color filter substrate 20 in the stated order. When the liquid crystal display device according to Embodiment 1 is the reflective type or the transflective type, the array substrate 10 includes a reflector for reflecting outside light.

The liquid crystal display device according to Embodiment 1 may include a color filter on array configuration; that is, the array substrate 10 includes a color filter. The liquid crystal display device according to Embodiment 1 may also be a monochrome display device or a field sequential color display device, and in this case, there is no need to arrange a color filter.

The liquid crystal layer 30 is filled with a liquid crystal material having the property of being aligned in a specific direction by applying a certain voltage thereto. The alignment of liquid crystal molecules in the liquid crystal layer 30 is controlled by the application of a threshold or higher voltage.

The liquid crystal display device of Embodiment 1 is preferably usable for TV, digital signage, medical applications, electronic books, PC (personal computers), portable terminals, etc. The same shall apply to the following embodiments.

Analysis of components of the alignment films, and the like can be performed by decomposing the liquid crystal display device according to Embodiment 1 and chemically analyzing the respective components using gas chromatograph mass spectrometry (GC-MS), time-of-fright secondary ion mass spectrometry (TOF—SIMS) and the like. In the embodiments described below, analysis of components of monomers included in the PS layers can be also performed. In addition, the cross-sectional shape of a liquid crystal cell including the photo-alignment films and the PS layers can be confirmed by microscopic observation using a scanning transmission electron microscope (STEM), a scanning electron microscope (SEM) or the like.

Hereinafter, an example of actually preparing a liquid crystal cell included in the liquid crystal display device according to Embodiment 1 will be described.

### Example 1

A glass substrate on which a pair of combteeth electrodes which are transparent electrodes are provided (combteeth electrodes substrate) and a bare glass substrate (counter substrate) were prepared. A polyvinyl cinnamate solution which was a material of a horizontal alignment film was applied to the respective substrates by a spin coating method. As glass for the glass substrate, #1737 (manufactured by Corning Inc.) was used.

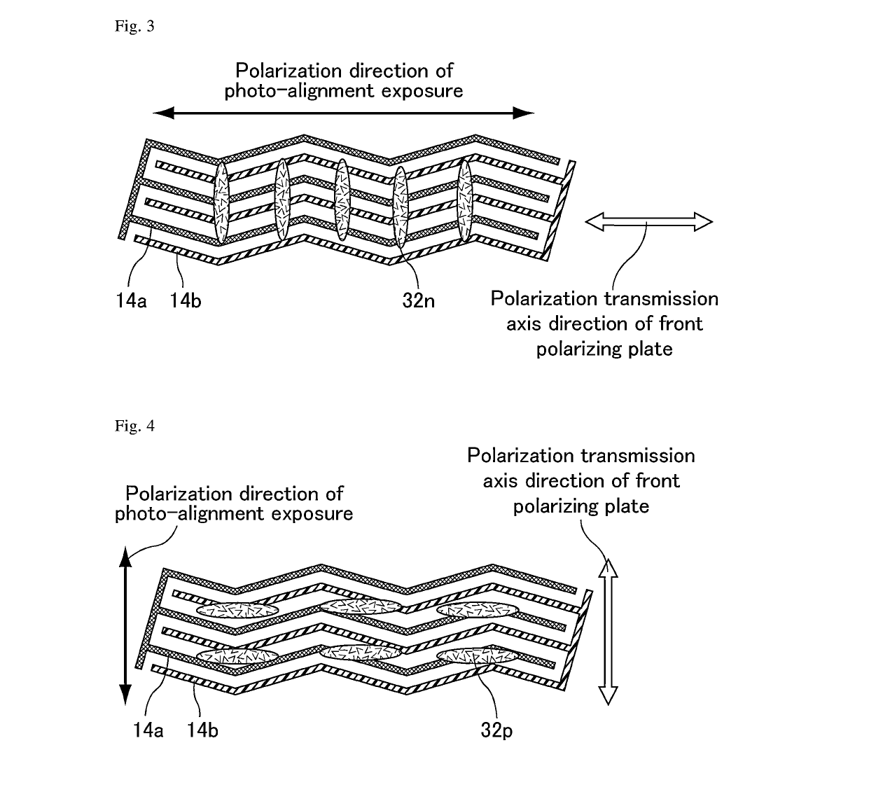

FIG. 3 is a plan view schematically illustrating a light irradiation polarization direction, combteeth electrodes, and a liquid crystal alignment direction in a liquid crystal display device according to Embodiment 1. In the pair of combteeth electrodes, as illustrated in FIG. 3, a pixel electrode 14a and a common electrode 14b extend substantially parallel to each other and are respectively formed in a zigzag shape. As a result, since the electric field vector during electric field application is substantially perpendicular to a lengthwise direction of the electrodes, a multidomain structure is formed and thus superior viewing angle characteristic can be obtained. As a material for the combteeth electrodes, IZO (indium zinc oxide) was used, but for example, ITO (indium tin oxide) may be also used preferably. The polyvinyl cinnamate solution was prepared by dissolving polyvinyl cinnamate in an amount of 3% by weight in a solvent obtained by mixing N-methyl-2-pyrrolidone and ethylene glycol monobutyl ether in equal amount.

After application by a spin coating method, provisional drying was performed at 90° C. for 1 minute, followed by baking at 200° C. for 60 minutes while purging nitrogen gas. The thickness of the alignment films after baking was 100 nm.

Next, as a photo-alignment treatment, the surface of each substrate was irradiated with linearly polarized ultraviolet rays having a wavelength of 313 nm and an intensity of 5 J/cm² from the normal direction of each substrate. A double-headed arrow in FIG. 3 shows the polarization direction of polarized ultraviolet rays in the alignment treatment (the case of using negative liquid crystal molecules 32n [Δ∈<0] having negative anisotropy of dielectric constant). As shown in FIG. 3, the polarization direction of polarized ultraviolet rays is perpendicular to the liquid crystal alignment direction at the time of no voltage application. Since the material of the horizontal alignment film in Embodiment 1 contains a polymer including a molecular structure (a repeating unit) represented by the following formula (2):

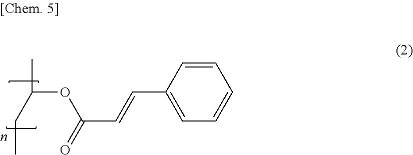

(in the formula, n represents an integer of 2 or greater and more preferably 8 or greater.), liquid crystal molecules are aligned in the direction perpendicular to the polarization direction of polarized light irradiated to the photo-alignment film by the polarized light irradiated to the photo-alignment film. Herein, the effects of the present invention can be exhibited if the material contains the repeating unit in an amount of 25% by mole or greater in all monomer units. The photo-alignment film of the liquid crystal display device according to Embodiment 1 is actually formed by photo-alignment of polyvinyl cinnamate. In place of polyvinyl cinnamate, a photo-alignment film material in which liquid crystal molecules are aligned in the direction perpendicular to the polarization direction of polarized light irradiated to the photo-alignment film by irradiation with polarized light in such a manner can be used, and the photo-alignment film materials represented by the formula (1) above, photo-alignment film materials including a chalcone group, a stilbene group, a coumarin group, an azo group or the like, etc., can be properly used without particular limitation, and the materials can generate the effect for stabilizing alignment which is the same as that in Embodiment 1. Especially, photo-alignment film materials including a cinnamate group, a chalcone group, a stilbene group, an azo group, or the like, which is a photoisomerizable group, are preferable.

At this time, as illustrated in FIG. 3, an angle formed between the lengthwise direction of the combteeth electrodes and the polarization direction was set to ±15°.

Next, a thermosetting seal material (HC1413EP, manufactured by Mitsui Chemicals, Inc.) was printed on the combteeth electrodes substrate by using a screen plate. Furthermore, in order to obtain the liquid crystal layer having a thickness of 3.5 μm, beads (SP-2035, manufactured by Sekisui Chemical Co., Ltd.) having a diameter of 3.5 μm were dispersed on the counter substrate. These two kinds of substrates were aligned such that the polarization directions of ultraviolet rays irradiating the respective substrates match with each other, and then were bonded.

Next, the bonded substrates were heated at 200° C. for 60 minutes in a furnace in which nitrogen gas was purged while applying a pressure of 0.5 kgf/cm² thereto, and thereby the seal material was cured. As the liquid crystal material, a negative type liquid crystal having negative anisotropy of dielectric constant was used.

An inlet of a cell through which the liquid crystal composition was injected was blocked with an ultraviolet ray-curable resin (TB3026E, manufactured by ThreeBond Co., Ltd.) and was sealed by irradiation with ultraviolet rays. The wavelength of ultraviolet rays irradiated for sealing was 365 nm, and light was shielded in pixel portions so as to remove the influence of ultraviolet rays as much as possible. At this time, electrodes were short-circuited and the charge of a surface of the glass substrate was eliminated such that the alignment of liquid crystal was not disordered by outside electric field.

Next, in order to remove the flow alignment of liquid crystal molecules, a realignment treatment of heating the liquid crystal cell at 130° C. for 40 minutes to make the liquid crystal molecules have isotropic phase was performed. As a result, a liquid crystal cell was obtained in which liquid crystal molecules were uniaxially aligned in the plane of the substrates in a direction perpendicular to the polarization direction of ultraviolet rays irradiated to the alignment films.

The liquid crystal display device according to Example 1 was found to have improved light fastness to sunlight or the like, stabilized alignment of liquid crystal, and excellent display quality based on comparison with a liquid crystal display device according to Comparative Example 1 described below. This is supposed to be because even if sunlight comes in a panel, polarized light which actualizes the original alignment direction is irradiated to the panel and thus alignment disorder is hardly caused.

In Embodiment 1, a liquid crystal material having positive anisotropy of dielectric constant [Δ∈>0] can be used. In this case, in Embodiment 1 using the liquid crystal material having negative anisotropy of dielectric constant, it is necessary to turn both of the polarization direction of the photo-alignment treatment and the polarization transmission axis direction of the front side polarizing plate at 90 degrees. Other configurations are the same as those of Embodiment 1 using the liquid crystal material having negative anisotropy of dielectric constant.

FIG. 4 is a plan view schematically illustrating a light irradiation polarization direction, combteeth electrodes, and a liquid crystal alignment direction in a liquid crystal display device according to in Embodiment 1 in a case where a liquid crystal material having positive anisotropy of dielectric constant (liquid crystal molecules 32p) is used. When a relation of the major axis direction of liquid crystal molecules at a voltage lower than the threshold voltage and the electrode direction in the liquid crystal display device is explained, particularly in the case of the IPS mode and the FFS mode, the anisotropy of dielectric constant (positive or negative) of the liquid crystal determines the relation of the major axis direction of liquid crystal molecules and the electrode direction. In a case where the anisotropy of dielectric constant is positive, the major axis direction of liquid crystal molecules at a voltage lower than the threshold voltage becomes parallel to the electrode direction (perpendicular to the electric field direction), and in a case where the anisotropy of dielectric constant is negative, the major axis direction of liquid crystal molecules at a voltage lower than the threshold voltage becomes perpendicular to the electrode direction (parallel to the electric field direction). The reason for this is because the axis with higher dielectric constant of liquid crystal molecules tends to direct to the electric field direction at a threshold voltage or greater. Herein, if the major axis direction of liquid crystal molecules at a voltage lower than the threshold voltage is made completely parallel or perpendicular to the electrode direction, the alignment defects (display failure) may be caused because liquid crystal molecules do not turn orderly in one direction when a threshold or higher voltage is applied. In order to eliminate the alignment defects, one of preferable embodiments of the present invention is that the major axis is previously shifted by about 1 to 15°. That is based on the same ground for giving a pre-tilt angle to a liquid crystal display panel of a TN mode or the like.

In addition, the anisotropy of dielectric constant Δ∈ of liquid crystal is represented by the following equation.

Δ∈=∈(parallel)−∈(vertical)

In the equation, ∈ (parallel) represents dielectric constant in the major axis of liquid crystal and c (vertical) represents dielectric constant in the minor axis of liquid crystal.

### Modified Example of Embodiment 1

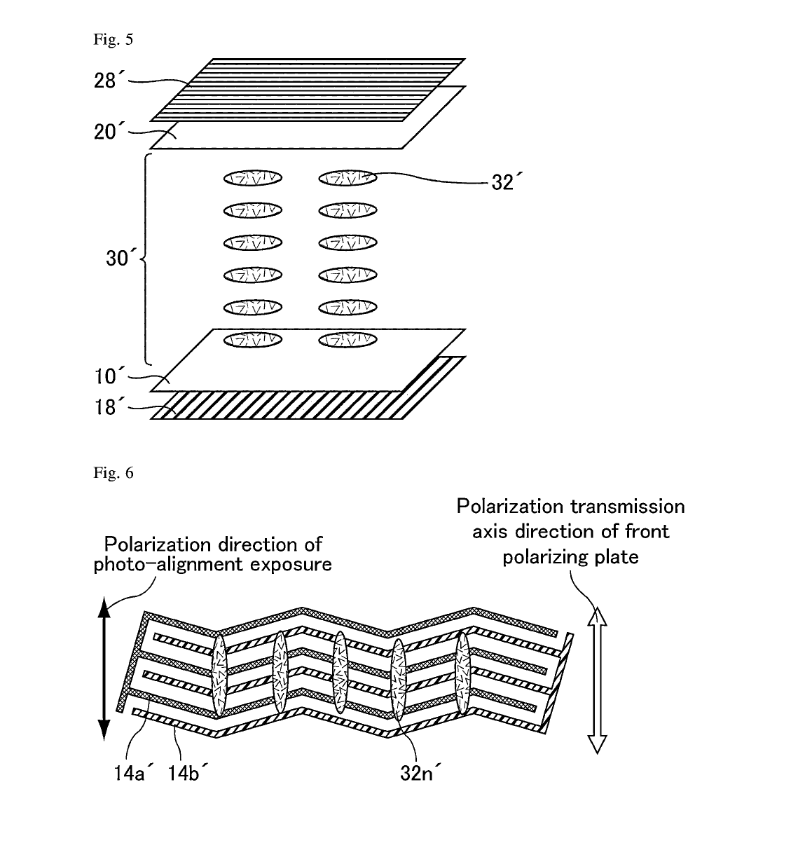

FIG. 5 is a perspective view schematically illustrating a liquid crystal display device according to a modified example of Embodiment 1 at a voltage lower than the threshold voltage. In the modified example of Embodiment 1, as shown in FIG. 5, the polarization transmission axis direction of the polarizing element is parallel to the liquid crystal alignment direction.

FIG. 6 is a plan view schematically illustrating a light irradiation polarization direction, combteeth electrodes, and a liquid crystal alignment direction in a liquid crystal display device according to the modified example of Embodiment 1. FIG. 6 shows the case of using a liquid crystal material having negative anisotropy of dielectric constant (Δ∈<0). In the modified example of Embodiment 1, as shown in FIG. 6, the material constituting the photo-alignment film aligns liquid crystal molecules in a direction parallel to the polarization direction of polarized light irradiated to the photo-alignment film by polarized light irradiated to the photo-alignment film. An angle formed between the lengthwise direction of the combteeth electrodes and the polarization direction of the polarized ultraviolet rays was set to ±75° as a photo-alignment treatment. In the modified example of Embodiment 1, as a material constituting the photo-alignment film, a material for aligning liquid crystal molecules in the direction parallel to the polarization direction of polarized light irradiated to the photo-alignment film by the polarized light irradiated to the photo-alignment film is used in place of polyvinyl cinnamate in Embodiment 1. For example, poly[methyl(p-methacryloyloxy)cinnamate], which is a polymer including a molecular structure (a repeating unit) represented by the following formula (4):

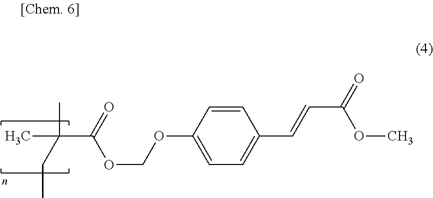

is preferably used. (in the formula, n represents an integer of 2 or greater and more preferably 8 or greater.) Herein, the effects of the present invention can be exhibited if the material contains the repeating unit in an amount of 25% by mole or greater in all monomer units. The photo-alignment film of the liquid crystal display device according to the modified example of Embodiment 1 is actually formed by photo-alignment of poly[methyl(p-methacryloyloxy)cinnamate]. In place of poly[methyl(p-methacryloyloxy)cinnamate], a photo-alignment film material in which liquid crystal molecules are aligned in the direction parallel to the polarization direction of polarized light irradiated to the photo-alignment film by irradiation with polarized light in such a manner can be used, and the photo-alignment film materials represented by the formula (3) above, photo-alignment film materials including a chalcone group, a stilbene group, a coumarin group, an azo group or the like, etc., can be properly used without particular limitation, and the materials can generate the effect for stabilizing alignment which is the same as that in the modified example of Embodiment 1. Especially, photo-alignment film materials including a cinnamate group, a chalcone group, a stilbene group, an azo group, or the like, which is a photoisomerizable group, are preferable.

Other configurations of the modified example of Embodiment 1 are the same as those of Embodiment 1 described above. If sunlight comes in a panel, polarized light which actualizes the original alignment direction is irradiated to the panel and thus alignment disorder can be hardly caused even in the configuration of the modified example of Embodiment 1. Accordingly, the same effect as that of Embodiment 1 can be exerted.

Also in the modified example of Embodiment 1, a liquid crystal material having positive anisotropy of dielectric constant (Δ∈>0) can be used. In the case of using a liquid crystal material having positive anisotropy of dielectric constant, it is necessary to turn both of the polarization direction of the photo-alignment treatment and the polarization transmission axis direction of the front side polarizing plate at 90 degrees from those of the case of using a liquid crystal material having negative anisotropy of dielectric constant. Other configurations in the case of using a liquid crystal having positive anisotropy of dielectric constant are the same as those in the case where of using a liquid crystal having negative anisotropy of dielectric constant.

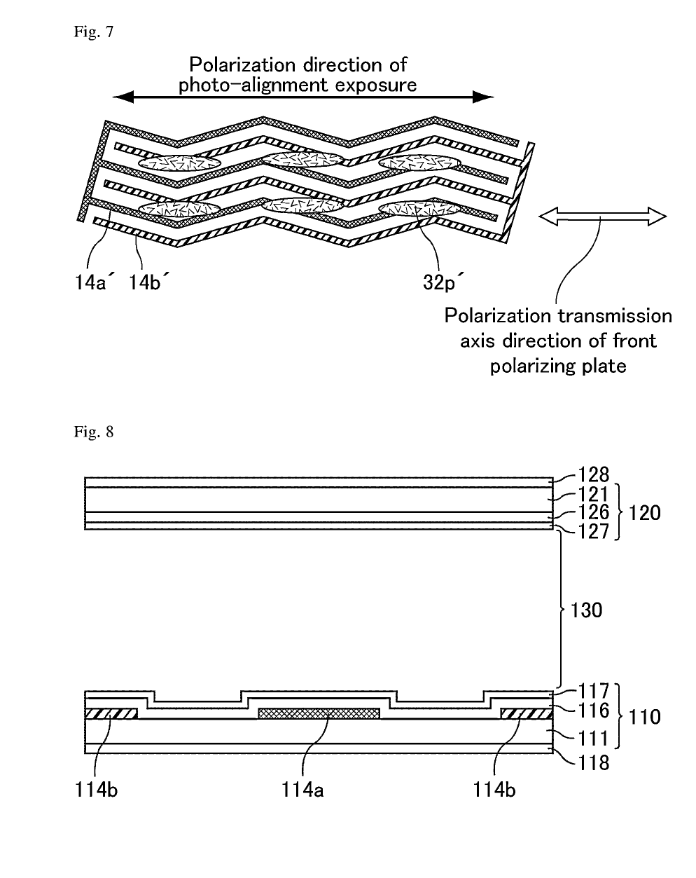

FIG. 7 is a plan view schematically illustrating a light irradiation polarization direction, combteeth electrodes, and a liquid crystal alignment direction in a liquid crystal display device according to the modified example of Embodiment 1 in a case where a liquid crystal material having positive anisotropy of dielectric constant (Δ∈>0) is used. In the modified example of Embodiment 1, it is preferable that the major axis direction of liquid crystal molecules at a voltage lower than the threshold voltage be shifted from the direction completely parallel or perpendicular to the electrode direction by about 1 to 15° for improvement of the relation of the major axis of liquid crystal molecules at a voltage lower than the threshold voltage and the electrode direction, and prevention of alignment defects (display failure), and it is the same as that described in Embodiment 1 above.

There are four configurations in total according to the systems (properties of alignment film materials) of Embodiment 1/modified example of Embodiment 1 and the systems of positive/negative liquid crystal materials as shown in FIG. 3, FIG. 4, FIG. 6, and FIG. 7.

### Embodiment 2

Embodiment 2 is the same as Embodiment 1, except that a PS layer is disposed on the photo-alignment film and liquid crystal is specified to be preferable as described below. FIG. 8 is a cross-sectional view schematically illustrating a liquid crystal display device according to Embodiment 2. PS layers 117 and 127 can be formed by injecting a liquid crystal composition containing a liquid crystal material and a polymerizable monomer between an array substrate 110 and a color filter substrate 120; irradiating a liquid crystal layer 130 with a certain amount of light or heating the layer; and thereby polymerizing the polymerizable monomer. The PS layers 117 and 127 improve the alignment regulating force of photo-alignment films 116 and 126. At this time, the PS layers 117 and 127 having a shape corresponding to the initial alignment of the liquid crystal molecules are formed by carrying out polymerization in a state where no voltage is applied or in a state where a voltage lower than the threshold voltage is applied to the liquid crystal layer 130, and thus the PS layers 117 and 127 can be provided with higher alignment stability. The liquid crystal composition may contain a polymerization initiator if necessary.

As the monomer, biphenyl-4,4′-diyl bis(2-methylacrylate) was used. Biphenyl-4,4′-diyl bis(2-methylacrylate) is a compound represented by the following chemical formula (5).

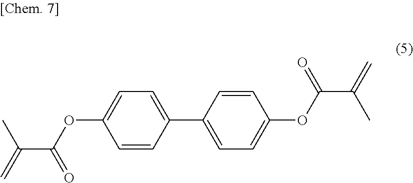 [SMILES: C=C(C)C(=O)Oc1ccc(-c2ccc(OC(=O)C(=C)C)cc2)cc1]

The amount of biphenyl-4,4′-diylbis(2-methyl acrylate) added is 1% by weight with respect to the total weight of the entire liquid crystal composition.

Next, in order to subject this liquid crystal cell to the PS process, the liquid crystal cell was irradiated with ultraviolet rays having an intensity of 2 J/cm² by using a black light unit (FHP32BLB, manufactured by TOSHIBA Corporation). As a result, biphenyl-4,4′-diyl bis(2-methyl acrylate) was polymerized.

The reaction systems (pathways of generating acrylate radicals) of the PS process in Embodiment 2 are as follows.

Biphenyl-4,4′-diyl bis(2-methyl acrylate), which is a monomer, is excited by irradiation with ultraviolet rays to form radicals. On the other hand, polyvinyl cinnamate, which is the photo-alignment film material, is also excited by irradiation with ultraviolet rays. Biphenyl-4,4′-diyl bis(2-methyl acrylate), which is a monomer, is excited to form radicals by the energy transfer from excited polyvinyl cinnamate.

The reason why the reactivity of the PS process is improved is considered to be as follows. In the process of polymerizing biphenyl-4,4′-diyl bis(2-methyl acrylate) which is the monomer with ultraviolet rays, it is considered that an intermediate such as a radical serves an important function. The intermediate is generated by ultraviolet rays, but the amount of the monomer in the liquid crystal composition is only slightly. Therefore, sufficient polymerization efficiency is not obtained only with the pathway in which the monomer is solely excited. When the PS process is performed only with the pathway, it is necessary that excited monomer intermediates be adjacent to each other in the liquid crystal bulk and thus the polymerization efficiency is low. In addition, since it is necessary that the monomer intermediates in which polymerization has already started move to the vicinity of the alignment films after the polymerization, the rate of the PS process is slow.

However, when the photo-alignment films are present, the photo-alignment films contain a large amount of double bonds as a photofunctional group such as polyvinyl cinnamate in the present example. Therefore, it is considered that the photofunctional groups are easily excited by ultraviolet rays and the excitation energy is transferred to the monomer in liquid crystal. Furthermore, since this energy transfer occurs in the vicinity of the alignment films, the existence probability of the monomer intermediates in the vicinity of the alignment films is significantly increased, thereby remarkably increasing the polymerization probability and the rate of the PS process.

In addition, in the photo-alignment films, electrons at a photoactive unit are excited by the irradiation with light. In addition, when the photo-alignment films are horizontal alignment films, the photoactive unit directly interacts with the liquid crystal layer to align liquid crystal. Therefore, the intermolecular distance between a photoactive unit and polymerizable monomers is shorter than that of a vertical alignment film and thus the probability of the transfer of excitation energy is significantly increased. When the photo-alignment films are vertical alignment films, there is inevitably a hydrophobic group between a photoactive unit and polymerizable monomers. Therefore, the intermolecular distance is increased and the energy transfer is difficult to occur. Therefore, the PS process is particularly preferable for a horizontal alignment film.

When observed by using a polarizing microscope, liquid crystal molecules in a photo-aligned IPS cell (liquid crystal cell of Embodiment 2), which was prepared with the above-described method and was subjected to the PS process, were uniaxially aligned in a favorable manner as was before the PS process. Furthermore, when liquid crystal was made to respond by applying a threshold or higher electric field thereto, the liquid crystal was aligned along zigzag-shaped combteeth electrodes and superior viewing angle characteristic was obtained by a multidomain structure.

Hereinafter, liquid crystal molecules in Embodiment 2 will be described in detail. The liquid crystal layer included in a liquid crystal display device of Embodiment 2 contains liquid crystal molecules including, in a molecular structure thereof, a multiple bond other than conjugated double bonds of a benzene ring or the like. Accordingly, PS process can be further promoted and as a result, the alignment of liquid crystal molecules can be further stabilized. The liquid crystal molecules may have either positive anisotropy of dielectric constant (positive type) or negative anisotropy of dielectric constant (negative type). The liquid crystal molecules in the present embodiment may include conjugated double bonds of a benzene ring or the like, that is, the conjugated double bonds are not excluded from it; as long as it includes a multiple bond other than conjugated double bonds of a benzene ring. In addition, the liquid crystal molecules included in the liquid crystal layer in the present embodiment, may be a mixture of plural kinds thereof. In order to secure the reliability, to improve the response speed, and to adjust the liquid crystal phase temperature range, the elastic constant, the anisotropy of dielectric constant, and the refractive index anisotropy, the liquid crystal contained in the liquid crystal layer may be a mixture of plural kinds of liquid crystal molecules.

It is preferable that the liquid crystal molecules include at least one molecular structure selected from a group consisting of structures represented by the following formulae (6-1) to (6-6). Among these, a molecular structure represented by the following formula (6-4) is particularly preferable.

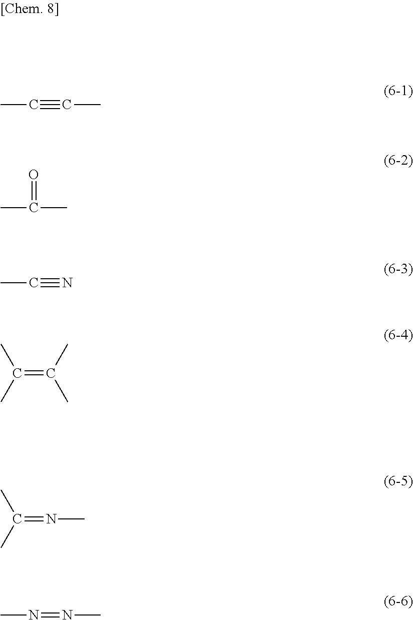

The liquid crystal molecules are preferable to include a structure in which two ring structures and groups bonded to the ring structures are linearly bonded to each other. More in detail, for example, liquid crystal molecules are preferable which include, as a core portion, a structure in which two ring structures of at least one kind selected from a benzene ring, cyclohexylene, and cyclohexene are linked to a para position by a direct bond or a linking group; and a structure in which at least one kind selected from a hydrocarbon group containing 1 to 30 carbon atoms and a cyano group which may include a substituent group and an unsaturated bond is bonded to both sides (para position) of the core portion.

The multiple bond is preferable to include a triple bond. In this case, the triple bond is preferable to be contained in a cyano group. For example, positive type liquid crystal 4-cyano-4′-pentylbiphenyl represented by the following chemical formula (7-1):

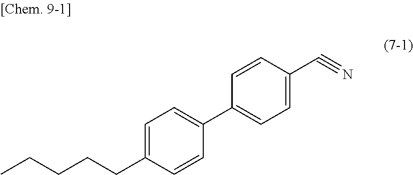 [SMILES: CCCCCc1ccc(-c2ccc(C#N)cc2)cc1]

is preferable. The liquid crystal molecules represented by the following chemical formula (7-2):

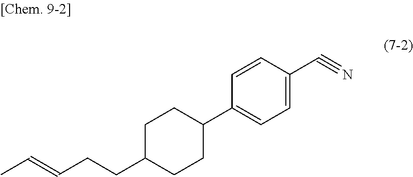 [SMILES: C/C=C/CCC1CCC(c2ccc(C#N)cc2)CC1]

are also preferable. Including a double bond in addition to a triple bond as the multiple bond other than a conjugated double bond, the liquid crystal molecules represented by the chemical formula (7-2) also has the following advantages of the double bond. The liquid crystal molecules represented by the following chemical formula (7-3):

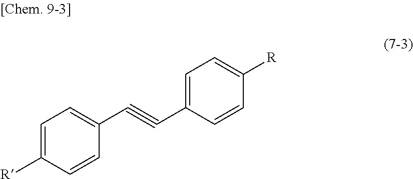

are also preferable although a triple bond is not contained in a cyano group. In the chemical formula (7-3), R and R′ may be the same or different from each other and each independently represents a hydrocarbon group containing 1 to 30 carbon atoms which may include a substituent group and an unsaturated bond.

In a case where the liquid crystal molecules include a multiple bond, the PS process is further promoted. The reason for this is supposed to be as follows. The excited monomer intermediates of Example 1 are generated by the energy transfer from ultraviolet rays and the photo-alignment films. However, in a liquid crystal material including a triple bond in the molecule, the liquid crystal molecules themselves may be excited by radicals and the like. It is also supposed that the PS process is promoted, for example, in the production pathway of generating the excited monomer intermediates by the energy transfer from ultraviolet rays and the liquid crystal material in addition to the reaction system of the energy transfer from ultraviolet rays and the photo-alignment film. Further, a pathway is also considered in which the energy is transferred from the excited photo-alignment films to liquid crystal molecules and thus the liquid crystal molecules are excited. That is, liquid crystal molecules include a multiple bond (for example, a triple bond or the like), and the monomer is excited through more pathways, and thus the PS process is further promoted.

The multiple bond is also preferable to include a double bond. The double bond is preferably contained in, for example, an ester group or an alkenyl group. Regarding the multiple bond, a double bond is more excellent in reactivity than a triple bond. Further, trans-4-propyl-4′-vinyl-1,1′-cyclohexane represented by the following chemical formula (8-1):

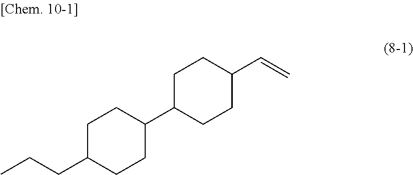 [SMILES: C=CC1CCC(C2CCC(CCC)CC2)CC1]

is also particularly preferable as liquid crystal. It can be said that trans-4-propyl-4′-vinyl-1,1′-bicyclohexane has higher excitation efficiency from ultraviolet rays and higher energy transfer efficiency from the photo-alignment film and between liquid crystal molecules than those of 4-cyano-4′-pentylbiphenyl. The difference of reactivity between these two molecules is whether the triple bond of a cyano group or an alkenyl group is contained in the molecules. In other words, a double bond has higher reaction efficiency than a triple bond. Similarly, the liquid crystal molecules represented by the following chemical formula (8-2):

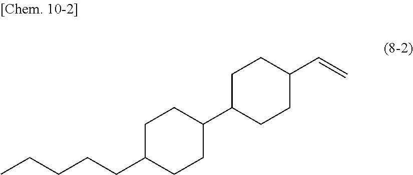 [SMILES: C=CC1CCC(C2CCC(CCCCC)CC2)CC1]

are also preferable. The liquid crystal molecules represented by the following chemical formula (8-3):

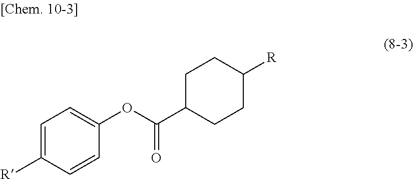

are also preferable as liquid crystal molecules including a double bond in an ester group. In the chemical formula (8-3), R and R′ may be the same or different from each other and each independently represents a hydrocarbon group containing 1 to 30 carbon atoms which may include a substituent group and an unsaturated bond. The liquid crystal molecules represented by the following chemical formula (8-4):

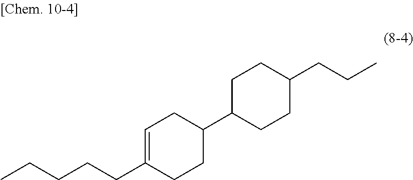 [SMILES: CCCCCC1=CCC(C2CCC(CCC)CC2)CC1]

are also preferable.

The alignment stability in a liquid crystal display device which is provided with a PS layer was improved by specifying the liquid crystal layer as described above.

### Embodiment 3

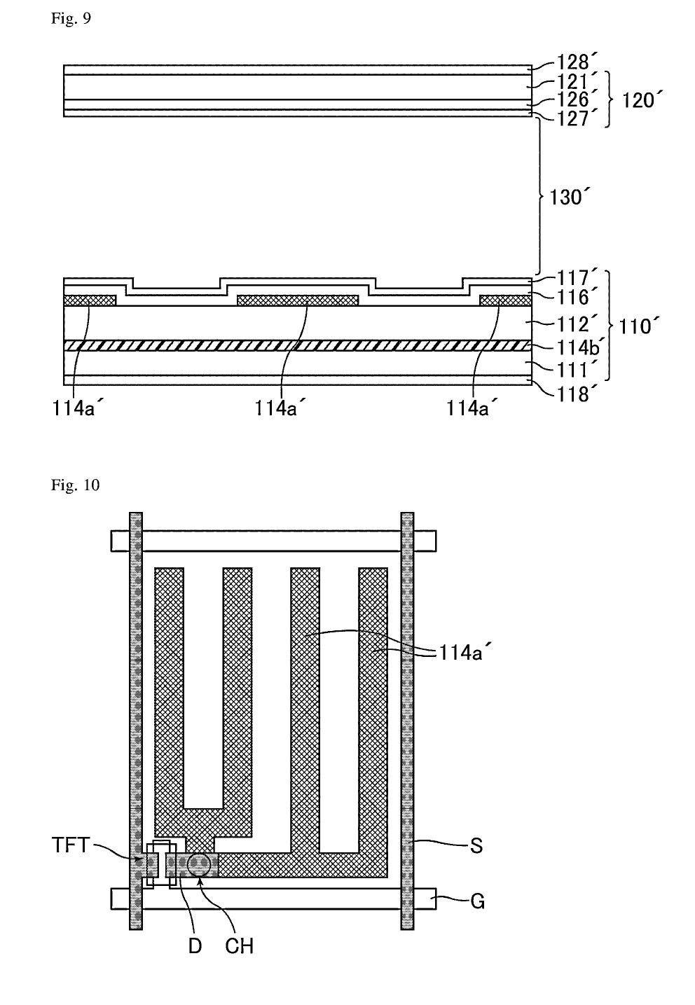

Embodiment 3 relates to a liquid crystal display device of the FFS mode. FIG. 9 is a cross-sectional view schematically illustrating a liquid crystal display device according to Embodiment 3. An array substrate 110′ includes an insulating transparent substrate 111′ made of a material such as glass and also includes a planar electrode 114b′ disposed on the transparent substrate 111′. An insulating film 112′ is disposed on the planar electrode 114b′. Various wirings, a combtooth electrode 114a′, TFT, and the like are disposed on the insulating film 112′. That is, the combtooth electrode 114a′ and the planar electrode 114b′ are formed in separate layers through the insulating film 112′. A color filter substrate 120′ includes an insulating transparent substrate 121′ made of a material such as glass, as well as a color filter, a black matrix, or the like formed on the transparent substrate 121′.

Further, the array substrate 110′ includes a photo-alignment film 116′ in a liquid crystal layer 130′ side of the transparent substrate 111′, and the color filter substrate 120′ also includes a photo-alignment film 126′ in the liquid crystal layer 130′ side. The photo-alignment films 116′ and 126′ are films containing polyimide, polyamide, polyvinyl, polysiloxane, and the like as a main component and subjected to photo-alignment treatment by irradiation with polarized light. Formation of the photo-alignment film can align liquid crystal molecules in a certain direction.

PS layers 117′ and 127′ can be formed by injecting a liquid crystal composition containing a liquid crystal material and a polymerizable monomer between the array substrate 110′ and the color filter substrate 120′; irradiating the liquid crystal layer 130′ with a certain amount of light or heating the layer; and thereby polymerizing the polymerizable monomer. The PS layers 117′ and 127′ improve the alignment regulating force of the photo-alignment films 116′ and 126′. At this time, the PS layers 117′ and 127′ having a shape corresponding to the initial alignment of the liquid crystal molecules are formed by carrying out polymerization in a state where no voltage is applied or in a state where a voltage lower than the threshold voltage is applied to the liquid crystal layer 130′, and thus the PS layers 117′ and 127′ can be provided with higher alignment stability. The liquid crystal composition may contain a polymerization initiator if necessary.

A rear side polarizing plate 118′ and a front side polarizing plate 128′ are provided in the back surface side of the array substrate 110′ and in the observation surface side of the color filter substrate 120′, respectively.

FIG. 10 is a plan view schematically illustrating pixels of a liquid crystal display device according to Embodiment 3. A voltage supplied from an image signal line S is applied to the combtooth electrode 114a′ driving the liquid crystal material through the thin film transistor (TFT) and a drain electrode D at the timing selected by a scanning signal line G. In addition, the combtooth electrode 114a′ is connected to the drain electrode D through a contact hole CH.

In Embodiment 3, in the same as Embodiment 1 and the modified example of Embodiment 1, even if the configuration is formed in which the polarization transmission axis direction of the polarizing element is perpendicular to the liquid crystal alignment direction and at the same time a material constituting a photo-alignment film aligns liquid crystal molecules in a direction perpendicular to the polarization direction of polarized light irradiated to the photo-alignment film by polarized light irradiated to the photo-alignment film, or the polarization transmission axis direction of the polarizing element is parallel to the liquid crystal alignment direction and at the same time a material constituting a photo-alignment film aligns liquid crystal molecules in a direction parallel to the polarization direction of polarized light irradiated to the photo-alignment film by polarized light irradiated to the photo-alignment film, more sufficient alignment stability can be exhibited and thus the effects of the present invention can be exerted. In other words, in Embodiment 3, a PS layer is formed on the photo-alignment film, and it is more preferable to form a PS layer as described above, but the effects of the present invention can be exerted without formation of the PS layer.

Examples of a general bonding method which is currently used in the mass production process of a liquid crystal panel include one drop filling. One drop filling is a method in which a liquid crystal composition is added dropwise to one substrate (for example, array substrate) and a pair of substrates is bonded to each other in a vacuum chamber. At this time, in order to efficiently hold an upper substrate (herein, for example, array substrate) in a vacuum, the electrostatic chuck was used. The electrostatic chuck is a device that generates a high-voltage and holds a substrate by using the electrostatic interaction. For example, when an FFS substrate (array substrate) and a counter substrate are bonded, a high voltage is applied from an electrostatic chuck positioned in the upper side of the FFS substrate to the FFS substrate. The FFS substrate includes a structure in which an insulating film, a planar electrode, an insulating film, and a combtooth electrode are laminated on a glass substrate in the stated order toward the liquid crystal layer side. The other substrate (counter substrate) is arranged on a stage, and a liquid crystal composition is added dropwise to a predetermined position on the counter substrate. An electric field generated from the electrostatic chuck extends toward the liquid crystal layer (space between the pair of substrates) side. However, since there is a single layer of the planar electrode in the FFS substrate, the electric field is blocked by the planar electrode. Accordingly, since the electric field is not applied to the liquid crystal layer and a photo-alignment film, the alignment of liquid crystal is not disordered by the influence of the electrostatic chuck and thus image sticking can be prevented.

On the other hand, when an IPS substrate is used, a planar electrode is not provided in the IPS substrate and an electric field generated from an electrostatic chuck pass between combteeth electrodes. Therefore, there is a concern that the alignment of liquid crystal may be disordered to cause image sticking. In order to solve this problem, it is necessary that a post-treatment for removing image sticking be performed after bonding. Therefore, in consideration of use of an electrostatic chuck, the FFS substrate is preferably used compared to the IPS substrates.

As described above, linearly polarized ultraviolet ray irradiation for photo-alignment treatment in Embodiments 1 to 3 is carried out before bonding a pair of substrates, but the photo-alignment treatment may be carried out from the outside of liquid crystal cell after a pair of substrates are bonded. The photo-alignment treatment is carried out regardless of before or after liquid crystal injection. However, in the case of linearly polarized ultraviolet ray irradiation for photo-alignment treatment after liquid crystal injection, the photo-alignment treatment and the PS process can be carried out simultaneously, and the process can be shortened advantageously. In this case, it is desirable that the time necessary for the photo-alignment treatment be shorter than the ultraviolet ray irradiation time required for the PS process.

In Embodiments 1 to 3, in the PS process, it is preferable that ultraviolet rays be irradiated from the side of the array substrate including an electrode. When ultraviolet rays are irradiated from the side of the counter substrate including color filters, the ultraviolet rays would be absorbed into the color filters.

The effects of the present invention are significant on a liquid crystal display device which requires substantially horizontal alignment among liquid crystal display devices using a photo-alignment film. Desirable alignment modes (display modes of liquid crystal display devices) of liquid crystal suitable for that are supposed to be, for example, the IPS mode, the FFS mode, the FLC mode, and the AFLC mode without any particular limitation, and especially, the IPS mode or the FFS mode is more preferable.

The effects of the present invention are particularly significant in the case of using a photo-alignment film by photoisomerization with low irradiation energy. Examples of a photoisomerizable group include, but are not limited to, a cinnamate group, a chalcone group, a stilbene group, and an azo group.

### Comparative Example 1

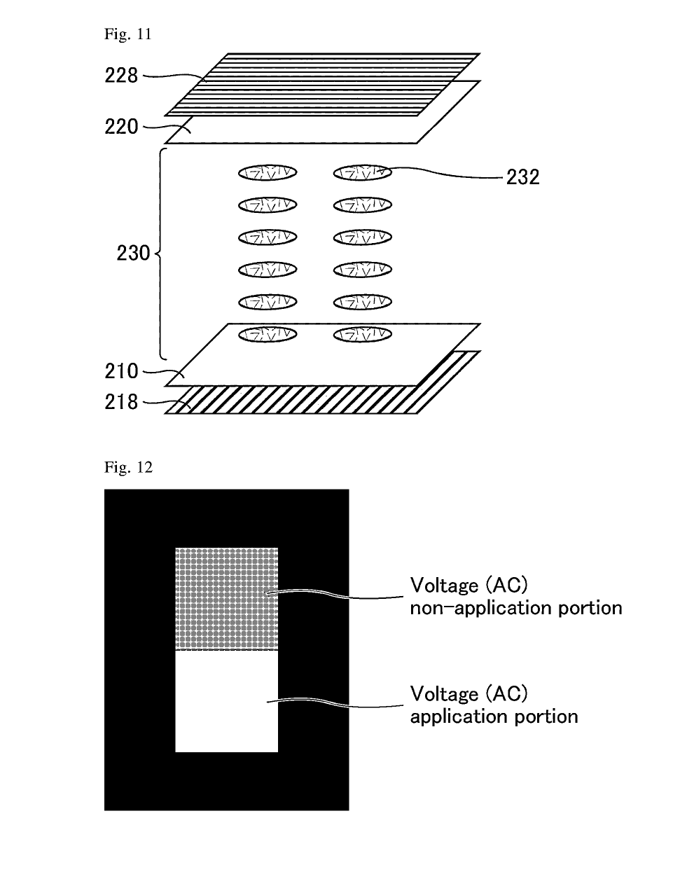

FIG. 11 is a perspective view schematically illustrating a liquid crystal display device according to Comparative Example 1 at a voltage lower than the threshold voltage. An IPS liquid crystal cell of Comparative Example 1 was prepared in the same manner as in Example 1, except that a polarizing element was arranged in such a manner that the polarization transmission axis direction of a polarizing element in the front side was parallel to the liquid crystal alignment direction. That is, the configuration of the liquid crystal display device according to Comparative Example 1 is the same as the configuration of the liquid crystal display device according to Embodiment 1, except that a polarizing element was arranged in such a manner that the polarization transmission axis direction of a polarizing element in the front side was parallel to the liquid crystal alignment direction, and the polarization direction of polarized ultraviolet rays is perpendicular to the liquid crystal alignment direction at the time of no voltage application.

Successively, the fastness of the liquid crystal cell of Example 1 and that of the liquid crystal cell of Comparative Example 1 to ultraviolet rays were evaluated.

### (Experiment 1)

The liquid crystal cell of Example 1 and the liquid crystal cell of Comparative Example 1 were used in environments from which all ultraviolet rays were completely removed even ultraviolet rays contained in light of a fluorescent lamp. As a result, the alignment was not disordered in both of Example 1 (the polarization direction of the front side polarizing plate was made perpendicular to the liquid crystal alignment direction) and Comparative Example 1 (the polarization direction of the front side polarizing plate was made parallel to the liquid crystal alignment direction).

### (Experiment 2)

The liquid crystal cell of Example 1 and the liquid crystal cell of Comparative Example 1 were used in environments such that sunlight came in panel surfaces.

Significant unevenness was caused in Comparative Example 1. It is considered that the cause of unevenness was ultraviolet rays on the surface. There was no problem in Example 1.

The difference between the IPS liquid crystal cell of Comparative Example 1 and the IPS liquid crystal cell of Example 1 was only the polarization direction of the front side polarizing plate. Accordingly, in the configuration of the liquid crystal display device according to the present invention, as described in Example 1, the polarization transmission axis direction of a polarizing plate was perpendicular to the alignment direction of the liquid crystal molecules at a voltage lower than the threshold voltage in the liquid crystal layer and the material constituting the photo-alignment film contained a material for aligning the liquid crystal molecules in a direction perpendicular to the polarization direction of polarized light irradiated to the photo-alignment film by polarized light irradiated to the photo-alignment film. This hardly causes alignment disorder because even if sunlight comes in a panel, polarized light which actualizes the original alignment direction is irradiated to the panel. It was thus found that the configuration was desirable in terms of excellent display quality. The same advantageous effect can be exerted by the configuration in which the polarization transmission axis direction of a polarizing plate is parallel to the alignment direction of liquid crystal molecules at a voltage lower than the threshold voltage in a liquid crystal layer, and the material constituting a photo-alignment film contains a material for aligning liquid crystal molecules in a direction parallel to the polarization direction of polarized light irradiated to the photo-alignment film by polarized light irradiated to the photo-alignment film.

A liquid crystal display device having the above-mentioned characteristics is preferable, but the effects of the present invention can be also exerted in the case of a liquid crystal display device in which the polarization transmission axis direction of a polarizing plate crosses the alignment direction of liquid crystal molecules at a voltage lower than the threshold voltage in a liquid crystal layer, and a material constituting a photo-alignment film contains a material for aligning the liquid crystal molecules in a direction crossing the polarization direction of polarized light irradiated to the photo-alignment film by polarized light irradiated to the photo-alignment film; or in the case of a liquid crystal display device in which the polarization transmission axis direction of a polarizing plate is along the alignment direction of liquid crystal molecules at a voltage lower than the threshold voltage in a liquid crystal layer, and a material constituting a photo-alignment film contains a material for aligning liquid crystal molecules in a direction along the polarization direction of polarized light irradiated to the photo-alignment film by polarized light irradiated to the photo-alignment film.

### Example 2

In a liquid crystal display device including a horizontal photo-alignment film, it is possible to sufficiently lower the image sticking by PS treatment. Hereinafter, this experimental example will be described in detail.

The current photo-alignment technique is usually introduced for mass-production of TVs using a vertical alignment film for the VA mode and the like; and has not yet been introduced for mass-production of TVs using a horizontal alignment film for the IPS mode and the like. The reason is that, when a horizontal alignment film is used, image sticking occurs to a large degree in liquid crystal display. Image sticking is the phenomenon in which, when the same amount of voltage is continuously applied to liquid crystal cell for a certain time, luminance appears to be different between portions to which a voltage is continuously applied and portions to which a voltage is not applied. Hereinafter, it is proved that a PS layer according to the present invention is effective to improve the image sticking.

FIG. 12 is a diagram schematically illustrating a state of image sticking in a liquid crystal cell of an IPS mode which is prepared by the present inventors performing a photo-alignment treatment. As illustrated in FIG. 12, there is a large difference in luminance between a voltage (AC) application portion and a voltage (AC) non-application portion, and it is found that image sticking occurs to an extremely large degree in the voltage (AC) application portion. In order to reduce image sticking, it is necessary that a polymer layer be stably formed by using the PS technique. To that end, it is necessary that polymerization for the PS process be promoted.

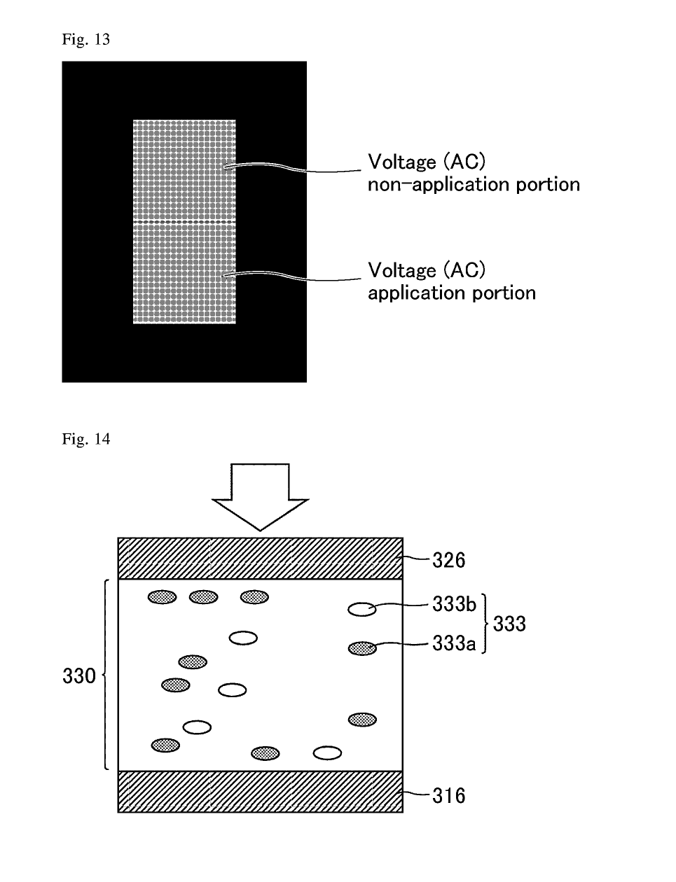

Therefore, in order to prepare a liquid crystal cell and a liquid crystal display device of the IPS mode using a photo-alignment treatment according to the present invention, which can satisfy a configuration in which a relation of the alignment direction of liquid crystal molecules and the polarization transmission axis direction of a polarizing element is specified and a material constituting a photo-alignment film is specified (for example, the configurations shown in Embodiment 1 and modified example of Embodiment 1 above), the present inventors investigated the introduction of a polymer stabilization (PS) process of adding a polymerizable monomer to liquid crystal and polymerizing the polymerizable monomer with heat or light to form a polymer layer on the interface with a liquid crystal layer. FIG. 13 is a diagram schematically illustrating a state of image sticking in a liquid crystal cell of an IPS mode which is prepared by the present inventors introducing a photo-alignment treatment and adopting the PS process. As illustrated in FIG. 13, there is no difference in luminance between a voltage (AC) application portion and a voltage (AC) non-application portion, and it is found that image sticking is improved in the voltage (AC) application portion. As described above, by adding the PS process to a method of the related art, image sticking was significantly improved.

The present inventors have investigated in various ways the reason why image sticking occurs to a large degree particularly in a liquid crystal cell of the IPS mode, and have found that there is a difference in the mechanism of image sticking between a liquid crystal cell of the IPS mode and a liquid crystal cell of the VA mode. According to the investigation by the present inventors, in the VA mode, image sticking occurs because the tilt in a polar angle direction remains (is memorized); whereas, in the IPS mode, image sticking occurs because the alignment in an azimuth direction remains (is memorized) and an electric double layer is formed. In addition, according to further investigation, it was found that these phenomena are caused by a material used for a photo-alignment film.

In addition, the present inventors have thoroughly investigated and found that the improvement caused by the PS process is particularly effective when an alignment film formed of a photoactive material is used. For example, it was found that, when an alignment film formed of a photoinactive material is subjected to a rubbing treatment or is not subjected any alignment treatment, the improvement caused by the PS process cannot be obtained.

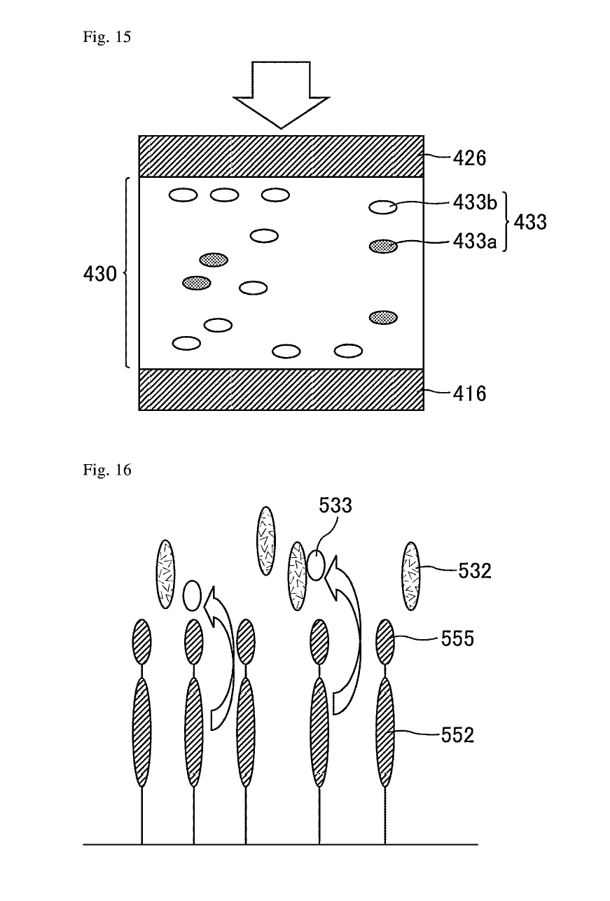

According to the investigation by the present inventors, the reason why the combination of the alignment film formed of a photoactive material with the PS process is preferable is as follows. FIG. 14 is a diagram schematically illustrating a polymerization state of a polymerizable monomer when an alignment film formed of a photoinactive material is subjected to the PS process, and FIG. 15 is a diagram schematically illustrating a polymerization state of a polymerizable monomer when an alignment film formed of a photoactive material is subjected to the PS process. As illustrated in FIGS. 14 and 15, in the PS process, a pair of substrates and a liquid crystal composition with which a gap between the pair of substrates is filled are irradiated with light such as ultraviolet rays (in the drawings, shown with the blanked arrow); the chain polymerization such as radical polymerization of a polymerizable monomer in a liquid crystal layer starts; and a formed polymer is deposited on surfaces of an alignment film on the side of the liquid crystal layer to form a polymer layer (also referred to as PS layer) for controlling the alignment of liquid crystal molecules.

As shown in FIG. 14, when alignment films 316 and 326 are photoinactive, polymerizable monomers 333b in a liquid crystal layer 330 which are excited by light irradiation are small and are uniformly generated in the liquid crystal layer 330. Excited polymerizable monomers 333b are photopolymerized, and polymer layers are formed by phase separation on the interfaces between the alignment films 316 and 326 and the liquid crystal layer 330. That is, in the PS process, there is a process in which the polymerizable monomers 333b excited in the bulk are photopolymerized and move to the interfaces between the alignment films 316 and 326 and the liquid crystal layer 330.

On the other hand, as shown in FIG. 15, when alignment films 416 and 426 are photoactive, a larger amount of polymerizable monomers 433b which are excited by light irradiation are formed in a liquid crystal layer 430 and are concentrated on the vicinity of the interfaces between the alignment films 416 and 426 and the liquid crystal layer 430. The reason is that the photo-alignment films 416 and 426 absorbs light when being irradiated with light and the excitation energy thereof is transferred to polymerizable monomers 433a. Due to this excitation energy, the polymerizable monomers 433a adjacent to the photo-alignment films 416 and 426 are easily changed to the polymerizable monomers 433b in excited state. Therefore, when the alignment films 416 and 426 are photoactive, a process in which the excited polymerizable monomers 433b are photopolymerized and move to the interfaces between the alignment films 416 and 426 and the liquid crystal layer 430 is negligible. Therefore, a polymerization rate and a rate of forming a polymer layer are improved, and thus a PS layer having a stable alignment regulating force can be formed.

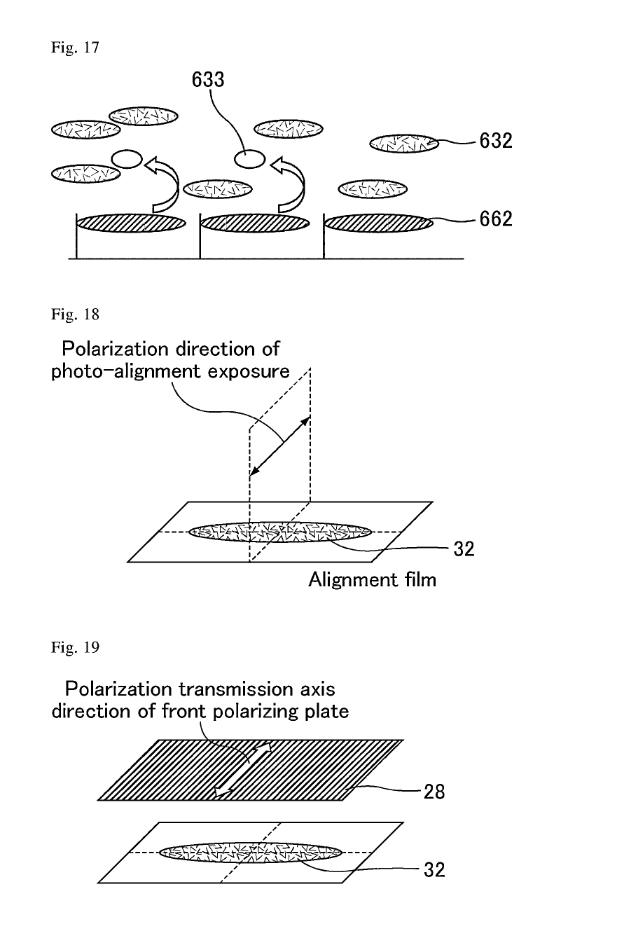

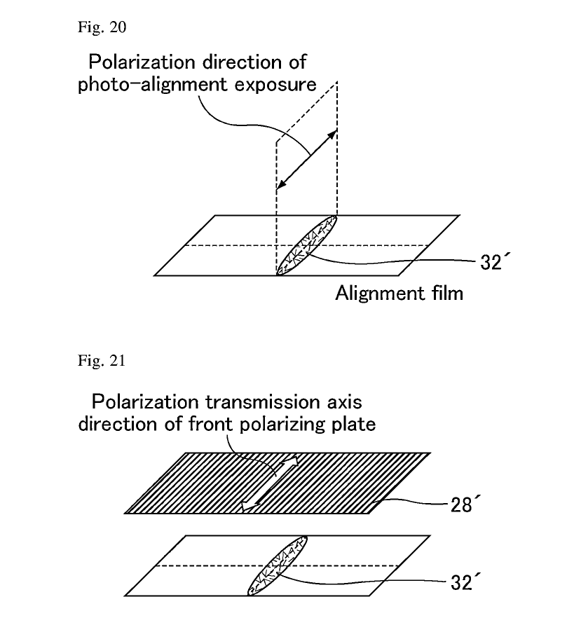

In addition, as a result of investigation, the present inventors found that the image sticking reduction effect by the PS layer is particularly effective for a horizontal alignment film rather than a vertical alignment film. The reason is considered to be as follows. FIG. 16 is a diagram schematically illustrating a state of a vertical alignment film when polymerizable monomers are polymerized. FIG. 17 is a diagram schematically illustrating a state of a horizontal alignment film when polymerizable monomers are polymerized.

When an alignment film is a vertical alignment film as illustrated in FIG. 16, photoactive groups 552 included in the vertical alignment film are in indirect contact with liquid crystal molecules 532 and polymerizable monomers 533 through hydrophobic groups 555. Therefore, the transfer of the excitation energy from the photoactive groups 552 to the polymerizable monomers 533 is difficult.

On the other hand, when an alignment film is a horizontal alignment film as illustrated in FIG. 17, photoactive groups 662 included in the horizontal alignment film are in direct contact with liquid crystal molecules 632 and polymerizable monomers 633. Therefore, the transfer of the excitation energy from the photoactive groups 662 to the polymerizable monomers 633 is easy. Therefore, a polymerization rate and a rate of forming a polymer layer are improved, and thus a PS layer having a stable alignment regulating force can be formed.

Accordingly, when the PS process is performed in a case where an alignment film is formed of a photoactive material and the alignment film is a horizontal alignment film, the transfer of the excitation energy is significantly improved and image sticking can be reduced to a large degree.

As clearly seen from the above description, in order to increase a rate of forming a PS layer and to improve alignment stability by electric application, that is, image sticking properties, it is preferable to use a photoactive material and to employ a horizontal alignment film as an alignment film. In addition, in order to transfer excitation energy between an alignment film and polymerizable monomers, a photo-excitable group may be generally used as a functional group of the alignment film or the like.

Further, in order to improve the image sticking property, it is particularly effective to make a liquid crystal material have the above-mentioned preferable configuration.

The polymer layer in the embodiments is preferable to be a polymerized product of a monomer which is polymerized by irradiation with visible light. Hereinafter, a monomer preferable in the present invention will be described in detail. A monomer used for polymer layer formation in the present invention can be determined by analyzing the molecular structure of a monomer unit in the polymer layer of the present invention.

The monomer for forming the polymer layer may be one kind, and is preferably one kind, or two or more kinds, and it is also preferable that the above-mentioned monomer polymerized by irradiation with visible light is a monomer for polymerizing another monomer (hereinafter, also referred to as a monomer having function of an initiator). The monomer having function of an initiator refers to a monomer which generates a chemical reaction by receiving visible light, initiates and promotes polymerization of another monomer which cannot be polymerized by itself by irradiation with visible light, and at the same time, carries out polymerization itself. The monomer having function of an initiator can make it possible to use many existing monomers which are not polymerized by visible light as a material for a polymer layer, and thus is significantly useful for obtaining a desired alignment film and polymer layer. Examples of the monomer having function of an initiator include monomers including a structure for generating radicals by irradiation with visible light.

Examples of the monomer having the function of an initiator include compounds represented by the following chemical formula (9).

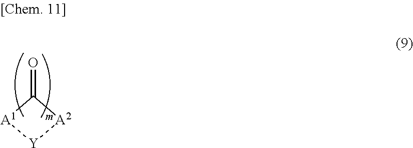

(In the formula, A¹ and A² are the same or different from each other and each independently represents a benzene ring, a biphenyl ring, or a linear or branched alkyl or alkenyl group having 1 to 12 carbon atoms; at least one of A¹ and A² includes a -Sp¹-P¹ group; a hydrogen atom included in A¹ and A² may be substituted with a -Sp¹-P¹ group, a halogen atom, a —CN group, an —NO₂ group, an —NCO group, an —NCS group, an —OCN group, an —SCN group, an —SF₅ group, or a linear or branched alkyl, alkenyl, or aralkyl group having 1 to 12 carbon atoms; two adjacent hydrogen atoms included in A¹ and A² may form a cyclic structure by being substituted with a linear or branched alkylene or alkenylene group having 1 to 12 carbon atoms; a hydrogen atom included in an alkyl group, an alkenyl group, an alkylene group, an alkenylene group, or an aralkyl group of A¹ and A² may be substituted with a -Sp¹-P¹ group; a —CH₂— group included in an alkyl group, an alkenyl group, an alkylene group, an alkenylene group, or an aralkyl group of A¹ and A² may be substituted with an —O— group, an —S— group, an —NH— group, a —CO— group, a —COO— group, an —OCO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CFS— group, an —SCF— group, an —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, or an —OCO—CH═CH— group as long as an oxygen atom, a sulfur atom, and a nitrogen atom are not adjacent to each other; P¹ represents a polymerizable group; Sp¹ represents a linear, branched or cyclic alkylene or alkyleneoxy group having 1 to 6 carbon atoms, or a direct bond; m represents 1 or 2; a dotted line connecting A¹ and Y and a dotted line connecting A² and Y show that a bond may exist between A¹ and A² through Y; Y represents a —CH₂— group, a —CH₂CH₂— group, a —CH═CH— group, an —O— group, an —S— group, an —NH— group, an —N(CH₃)— group, an —N(C₂H₅)— group, an —N(C₃H₇)— group, an —N(C₄H₉)— group, an —OCH₂— group, a —CH₂O— group, an —SCH₂— group, a —CH₂S— group, or a direct bond.)

More specific examples thereof include any of compounds represented by the following chemical formulae (10-1) to (10-8).

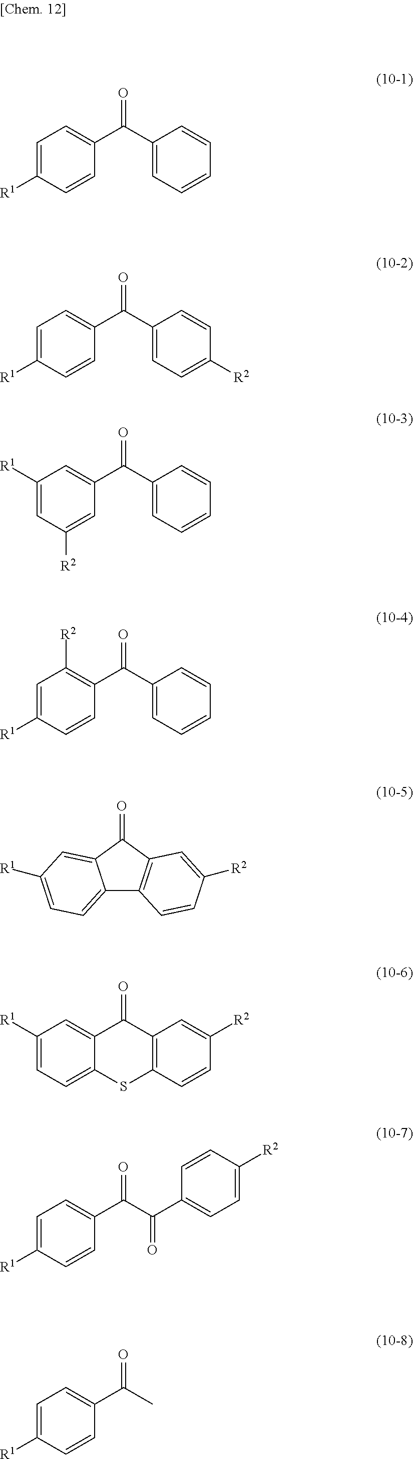

(In the formulae, R¹ and R² are the same or different from each other and each independently represents a -Sp¹-P¹ group, a hydrogen atom, a halogen atom, a —CN group, an —NO₂ group, an —NCO group, an —NCS group, an —OCN group, an —SCN group, an —SF₅ group, or a linear or branched alkyl, aralkyl, phenyl group having 1 to 12 carbon atoms; at least one of R¹ and R² includes a -Sp¹-P¹ group; P¹ represents a polymerizable group; Sp¹ represents a linear, branched, or cyclic alkylene or alkyleneoxy group having 1 to 6 carbon atoms, or a direct bond; when at least one of R¹ and R² represents a linear or branched alkyl, aralkyl, phenyl group having 1 to 12 carbon atoms, a hydrogen atom included in at least one of R¹ and R² may be substituted with a fluorine atom, a chlorine atom, or a Sp¹-P¹ group; a —CH₂— group included in R¹ and R² may be substituted with an —O— group, an —S— group, an —NH— group, a —CO— group, a —COO— group, an —OCO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, an —SCF₂— group, an —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, or an —OCO—CH═CH— group as long as an oxygen atom, a sulfur atom, and a nitrogen atom are not adjacent to each other.)

Examples of P¹ include an acryloyloxy group, a methacryloyloxy group, a vinyl group, a vinyloxy group, an acryloylamino group, and a methacryloylamino group. Herein, a part or all of the hydrogen atoms included in a benzene ring in the compounds represented by the chemical formulae (10-1) to (10-8) may be substituted with a halogen atom or an alkyl or alkoxy group having 1 to 12 carbon atoms, and a part or all of the hydrogen atoms included in the alkyl or alkoxy group may be substituted with a halogen atom. Further, the bonding positions of R¹ and R² to the benzene ring are not limited thereto.

The polymer layer is further preferably polymerized product of a monomer including a monofunctional or polyfunctional polymerizable group including one or more kinds ring structures. Examples of such a monomer include compounds represented by the following chemical formula (11).

[Chem. 13]

P²—Sₚ²—R⁴-A³-(Z-A⁴)ₙ-R³ (11)

(In the formula, R³ represents a —R⁴-Sp²-P² group, a hydrogen atom, a halogen atom, a —CN group, an —NO₂ group, an —NCO group, an —NCS group, an —OCN group, an —SCN group, an —SF₅ group, or a linear or branched alkyl group having 1 to 12 carbon atoms; P² represents a polymerizable group; Sp² represents a linear, branched, or cyclic alkylene or alkyleneoxy group having 1 to 6 carbon atoms, or a direct bond; a hydrogen atom included in R³ may be substituted with a fluorine atom or a chlorine atom; a —CH₂— group included in R³ may be substituted with may be substituted with an —O— group, an —S— group, an —NH— group, a —CO— group, a —COO— group, an —OCO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, an —SCF₂— group, an —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, or an —OCO—CH═CH— group as long as an oxygen atom and a sulfur atom are not adjacent to each other; R⁴ represents an —O— group, an —S— group, an —NH— group, a —CO— group, a —COO— group, an —OCO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, an —SCF₂— group, an —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, an —OCO—CH═CH— group or a direct bond; A³ and A⁴ are the same or different from each other and each independently represents a 1,2-phenylene group, a 1,3-phenylene group, a 1,4-phenylene group, a naphthalene-1,4-diyl group, a naphthalene-1,5-diyl group, a naphthalene-2,6-diyl group, a 1,4-cyclohexylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, a 1,2,3,4-tetrahydronaphthalene-2,6-diyl group, an indane-1,3-diyl group, an indane-1,5-diyl group, an indane-2,5-diyl group, a phenathrene-1,6-diyl group, a phenathrene-1,8-diyl group, a phenathrene-2,7-diyl group, a phenathrene-3,6-diyl group, an anthracene-1,5-diyl group, an anthracene-1,8-diyl group, an anthracene-2,6-diyl group, or an anthracene-2,7-diyl group; a —CH₂— group included in A³ and A⁴ may be substituted with an —O— group or an —S— group as long as they are not adjacent to each other; a hydrogen atom included in A³ and A⁴ may be substituted with a fluorine atom, a chlorine atom, a —CN group, or an alkyl, alkoxy, alkylcarbonyl, alkoxycarbonyl, or alkylcarbonyloxy group having 1 to 6 carbon atoms; Z is the same or different from each other and each independently represents an —O— group, an —S— group, an —NH— group, a —CO— group, a —COO— group, an —OCO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, an —SCF₂— group, an —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, an —OCO—CH═CH— group or a direct bond; and n represents 0, 1, or 2)

More specific examples thereof include any of compounds represented by the following chemical formulae (12-1) to (12-5).

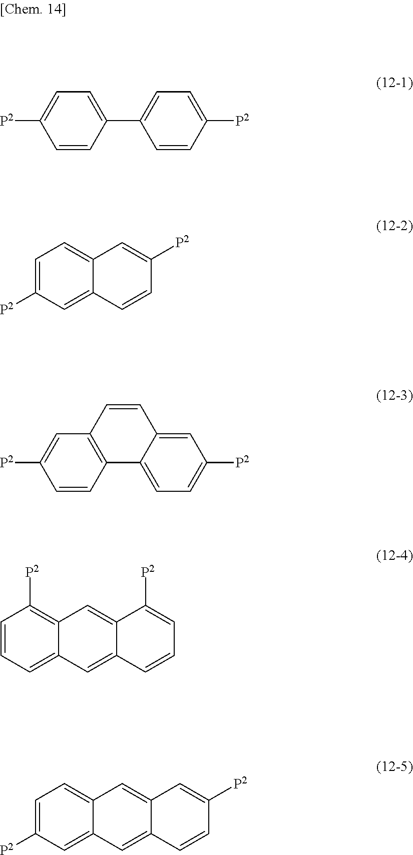

(In the formulae, P²s are the same or different from each other and each independently represents a polymerizable group.)

Examples of P² include an acryloyloxy group, a methacryloyloxy group, a vinyl group, a vinyloxy group, an acryloylamino group, and a methacryloylamino group. Herein, a part or all of the hydrogen atoms included in a benzene ring and a condensed ring in the compounds represented by the chemical formulae (12-1) to (12-5) may be substituted with a halogen atom or an alkyl or alkoxy group having 1 to 12 carbon atoms, and a part or all of the hydrogen atoms included in the alkyl or alkoxy group may be substituted with a halogen atom. The bonding position of P² to the benzene ring and the condensed ring is not limited thereto.

The monomers for forming the polymer layer (for example, compounds represented by the chemical formulae (10-1) to (10-8) and compounds represented by the chemical formulae (12-1) to (12-5)) are preferable to include two or more polymerizable groups. Examples thereof include those including two polymerizable groups.

In the present invention, addition of the monomer having a polymerization initiating function to liquid crystal without using a conventional polymerization initiator makes it possible to remarkably improve the electric properties without remaining a polymerization initiator which may become an impurity in a liquid crystal layer. At the time of polymerization of a monomer, it is preferable that a polymerization initiator for a monomer be substantially absent in the liquid crystal layer. In addition, due to an improvement in density of the reaction starting points, oligomer-like substances in which the polymer size is small immediately after light irradiation are easily formed, and the number of their production can be increased. The oligomer-like substances are quickly deposited on an alignment film surface based on the precipitation effect due to a solubility decrease in the liquid crystal layer (in bulk). Accordingly, as compared to a conventional technique, a polymer network is difficult to be formed in the liquid crystal layer, and the polymer size is not too large to form an extremely uniform polymer layer on the alignment film surface. Consequently, without shift of driving voltage and lowering of the contrast, the liquid crystal alignment on the alignment film surface can be efficiently fixed. Furthermore, the electric properties are not lowered and sufficient long time reliability can be attained. In order to prepare a liquid crystal display device according to the present invention, which can satisfy a configuration in which a relation of the alignment direction of liquid crystal molecules and the polarization transmission axis direction of a polarizing element is specified and a material constituting a photo-alignment film is specified (for example, the configurations shown in Embodiment 1 and modified example of Embodiment 1 above), Examples 3 to 6 will be described below which prove that an advantageous effect can be exerted by using the monomer having a polymerization initiating function.

### Example 3

The conditions of Example 3 were as follows.

Display mode: FFS

Alignment film material: Polyvinyl cinnamate

Alignment treatment: Irradiation with ultraviolet rays having polarized light (main reactive wavelength is 313 nm), irradiation energy was 100 mJ/cm², the alignment principle was photoisomerization and photodimerization.

Monomer: A monomer represented by the following chemical formula (13):

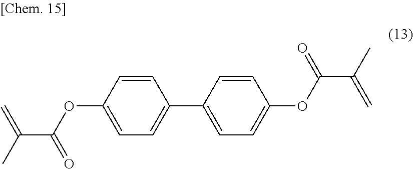 [SMILES: C=C(C)C(=O)Oc1ccc(-c2ccc(OC(=O)C(=C)C)cc2)cc1]

was added in an amount of 0.5% by weight to 100% by weight of the liquid crystal material.

PS treatment: After liquid crystal containing the monomer was sealed in a panel, light irradiation with black light was carried out.

Experiment results: Alignment stability, particularly image sticking property could be improved without increasing driving voltage, lowering the contrast, and considerably lowering the voltage holding ratio.

A biphenyl-based bifunctional methacrylate monomer was used as the monomer.

No photopolymerization initiator was added. However, polymer formation could be observed in this material system. It is supposed that the radical generation processes as illustrated in the following formulae (13-1) and (13-2):

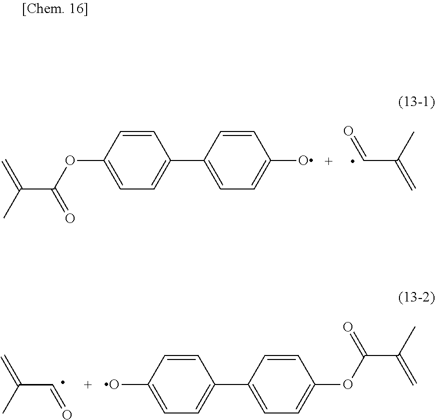

are generated by light irradiation. Further, owing to existence of a methacrylate group, the methacrylate group itself contributes to the polymer formation by the radical polymerization.

As the monomer, a monomer soluble in liquid crystal and being rod-like molecules are desirable. Other than the biphenyl-based monomer, naphthalene-based, phenanthrene-based, and anthracene-based monomers are supposed to be usable. A part or all of the hydrogen atoms included in the monomer may be substituted with a halogen atom, an alkyl, or alkoxy group (a part or all of the hydrogen atoms of the groups may be substituted with a halogen atom).

As the polymerizable group, besides the methacryloyloxy group, an acryloyloxy group, a vinyloxy group, an acryloylamino group, and a methacryloylamino group are supposed to be usable. If such a monomer is used, radical generation is possible by light having a wavelength within a range from about 300 to 380 nm, and the monomer can be the monomer having a function of an initiator.

Besides the monomers, monomers such as acrylate and diacrylate having no photopolymerization initiating function may be mixed, and this can adjust the photopolymerization rate. The mixing can be one of effective means particularly in the case of suppressing polymer network production.

### Example 4

The conditions of Example 4 were as follows.

Display mode: IPS

Alignment film material: Polyvinyl cinnamate

Alignment treatment: Irradiation with ultraviolet rays having polarized light (main reactive wavelength is 313 nm), irradiation energy was 100 mJ/cm², the alignment principle was photoisomerization and photodimerization.

Monomer: A mixture of a monomer represented by the following chemical formula (14A) and a monomer represented by the following chemical formula (14B) (mixing ratio by weight 50:50):

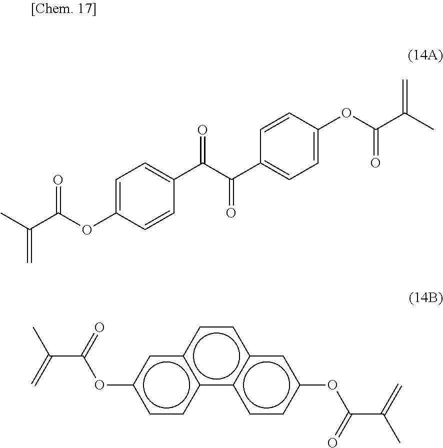

was added in an amount of 0.5% by weight to 100% by weight of the liquid crystal material.

PS treatment: After liquid crystal containing the monomer was sealed in a panel, light irradiation with visible light was carried out.

Experiment results: Alignment stability, particularly image sticking property could be improved without increasing driving voltage, lowering the contrast, and considerably lowering the voltage holding ratio.

A mixture of a monomer represented by the chemical formula (14A) above and a monomer represented by the chemical formula (14B) above was used as the monomer.

In the present example, irradiation in the PS process was carried out with visible light. Accordingly, damages on the liquid crystal and the photo-alignment film can be suppressed.

The monomer (14B) does not generate radicals by light with a wavelength of 380 nm or longer. However, a monomer such as the monomer (14A) (referred to also as benzyl-based monomer in this specification) absorbs light with a wavelength of 380 nm or longer to generate radicals. The monomer itself can form a portion of the polymer layer while being polymerized.

As the monomer, it is supposed to be benzoin ether-based, acetophenone-based, benzyl ketal-based, and ketone-based monomers, which generate radicals by photocleavage or hydrogen removal. Further, it is necessary for these monomers to include a polymerizable group, and thus besides the methacryloyloxy group, an acryloyloxy group, a vinyloxy group, an acryloylamino group, and a methacryloylamino group are supposed to be possible.

In the photo-alignment film of Example 3 and Example 4, polyvinyl cinnamate including a double bond was used, and thus it is supposed that the cinnamate group could further contribute to promotion of photopolymerization for the PS layer and uniform layer formation since the cinnamate group was subjected to light excitation to provide radicals.

As such a photo-alignment film, photo-alignment films including a chalcone group, a coumarin group, a stilbene group, and an azo group can be used similarly as photo-alignment films including double bonds, and thus they are supposed to be effective.

As a main chain of the polymer, polyamic acid, polyimide, polyamide, polysiloxane, and polymaleimide are also usable.

The irradiation energy for photo-alignment was set to 100 mJ/cm², but the alignment can be stabilized by the PS process even with irradiation energy of 100 mJ/cm² or lower, and thus there is no problem for practical application. Rather, lowering of the irradiation energy is desirable since the photodeterioration of other members can be suppressed.

### Example 5

The conditions of Example 5 were as follows.

Display mode: IPS

Alignment film material: Polyimide including cyclobutane in the skeleton.

Alignment treatment: Irradiation with ultraviolet rays having polarized light (main reactive wavelength is 254 nm), irradiation energy was 500 mJ/cm², the alignment principle is photodissociation of cyclobutane.

Monomer: A monomer represented by the following chemical formula (15):

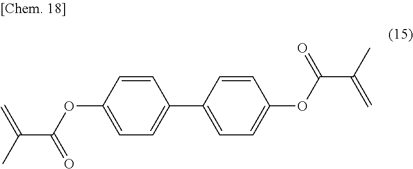 [SMILES: C=C(C)C(=O)Oc1ccc(-c2ccc(OC(=O)C(=C)C)cc2)cc1]

was added in an amount of 0.5% by weight to 100% by weight of the liquid crystal material.

PS treatment: After liquid crystal containing the monomer was sealed in a panel, light irradiation with black light was carried out.

Experiment results: Alignment stability, particularly image sticking property could be improved without increasing driving voltage, lowering the contrast, and considerably lowering the voltage holding ratio.

As the monomer, a monomer was used similarly in Example 3, but it is needless to say that the monomer of Example 4 can be also used.

Although the irradiation energy for photo-alignment was set to 500 mJ/cm², it was not possible to obtain sufficient alignment properties without the PS process. On the other hand, if the PS process was performed, there was no problem for actual application with irradiation energy of 500 mJ/cm² or lower. In order to obtain sufficient alignment properties without the PS process, irradiation energy of about 2 J/cm² is necessary. High energy irradiation around 254 nm causes photodissociation of other parts in the alignment film and photodissociation of a color filter, and thus causes a problem on long time reliability; however the present invention could solve such problems.

### Example 6

The conditions of Example 6 were as follows.

Display mode: IPS

Alignment film material: Polyimide including cyclobutane in the skeleton (the same as in Example 5).

Alignment treatment: Rubbing

Monomer: A mixture of a monomer represented by the following chemical formula (16A) and a monomer represented by the following chemical formula (16B) (mixing ratio by weight 50:50):

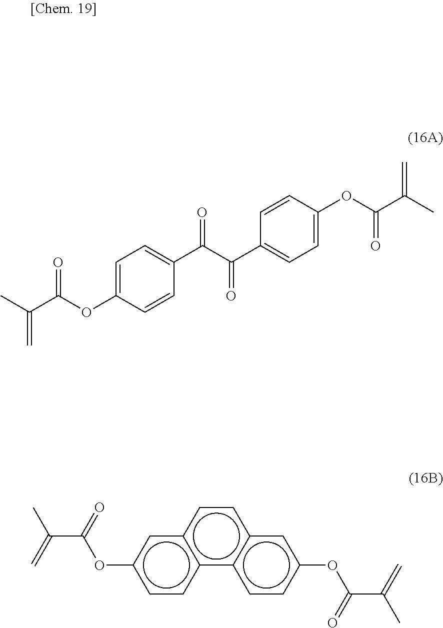

was added in an amount of 0.5% by weight to 100% by weight of the liquid crystal material.

PS treatment: After liquid crystal containing the monomer was sealed in a panel, light irradiation with visible light was carried out.

Experiment results: Alignment stability, particularly image sticking property could be improved without increasing driving voltage, lowering the contrast, and considerably lowering the voltage holding ratio.

As the monomer, a monomer was used similarly in Example 4, but it is needless to say that the monomer of Example 3 can be also used.

Rubbing treatment was carried out under the conditions that the push-down amount of a pile of a rubbing cloth was set to 0.5 mm and the number of rubbing was set to 3 times.

In Examples 2 to 6, as a method for forming the polymer layer, a photopolymerizable monomer was previously added to liquid crystal and the PS process was carried out, but the method for forming the polymer layer is not limited thereto.

For example, a method for adding a monomer to an alignment film also makes formation of a polymer layer possible, and thus it will be described in detail below. In place of previous addition of a monomer to liquid crystal, a monomer in a prescribed concentration is previously mixed with an alignment film ink, and thereafter, the same processes as described in Examples 2 to 6 are carried out for other processes. The monomer in the alignment film is eluted to the liquid crystal side by heating after sealing liquid crystal to a panel, and desirably heating the liquid crystal at phase transition temperature from nematic to isotropic phase or higher. Thereafter, if the light irradiation for the PS process which is the same as in Examples 2 to 6 is carried out, a polymer layer is formed. Particularly, it is possible that the heating process for curing a sealing material existing in the outer circumferential part of a liquid crystal panel can be carried out as the monomer elution process, and in this case, the monomer elution process does not need to be carried out additionally to the heating process for curing the sealing material, and as compared to the processes in Examples 2 to 6, no extra-process is increased.

A polymerizable functional group (polymerizable functional group of a monomer) to be included in the monomer is preferable to contain at least one kind selected from a group consisting of an acrylate group, a methacrylate group, a vinyl group, a vinyloxy group, and an epoxy group.

### Example 7

The conditions of Example 7 were as follows.

Display mode: FFS

Alignment film material: Polyvinyl cinnamate

Alignment treatment: Irradiation with ultraviolet rays having polarized light (main reactive wavelength is 313 nm), irradiation energy was 5 J/cm², the alignment principle was photoisomerization and photodimerization.

Monomer: A monomer represented by the following chemical formula (17):

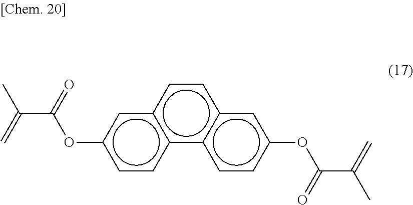

was added in an amount of 1.0% by weight to 100% by weight of the alignment film ink material.

PS treatment: A photo-alignment treatment was carried out by irradiating with polarized light after a monomer-containing alignment film ink was applied to a substrate and baked. After liquid crystal was sealed in a panel, the liquid crystal panel was heated at 130° C. for 40 minutes. Light irradiation with black light was carried out.

Experiment results: Alignment stability, particularly image sticking property could be improved without increasing driving voltage, lowering the contrast, and considerably lowering the voltage holding ratio.

The monomer is not limited thereto, and it is needless to say that the monomer in Example 3 can be also used. Further, a polymerization initiator may be added properly to promote polymerization.

As another method, a method for applying a monomer directly to an alignment film is also effective. A monomer is previously dissolved in a prescribed concentration in a solvent and applied to an alignment film, and then the solvent is removed. The solvent removal can be performed by heating and/or pressure reduction (for example, vacuuming). The application step may be carried out either before or after a photo-alignment treatment for the alignment film. If the light irradiation for the PS process is carried out after sealing liquid crystal in a panel, a polymer layer is formed. In the same manner as described above, the monomer can be more evenly dispersed in the liquid crystal by heating after sealing the liquid crystal in the panel, and desirably heating the liquid crystal at phase transition temperature from nematic to isotropic phase or higher, and thus display unevenness or the like can be suppressed.

### Example 8

The conditions of Example 8 were as follows.

Display mode: FFS

Alignment film material: Polyvinyl cinnamate

Alignment treatment: Irradiation with ultraviolet rays having polarized light (main reactive wavelength is 313 nm), irradiation energy was 5 J/cm², the alignment principle was photoisomerization and photodimerization.

Monomer: A monomer represented by the following chemical formula (18):

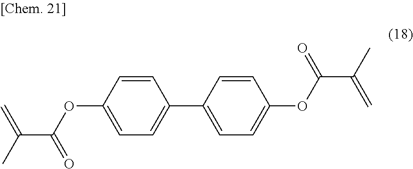 [SMILES: C=C(C)C(=O)Oc1ccc(-c2ccc(OC(=O)C(=C)C)cc2)cc1]

was added in an amount of 1.0% by weight to 100% by weight of solvent acetone.

PS treatment: A photo-alignment treatment was carried out by irradiating with polarized light after an alignment film ink was applied to a substrate and baked, and thereafter, a solution of 1.0% by weight of the monomer was applied thereto. The solvent was evaporated by heating at 130° C. and again the photo-alignment treatment was carried out by irradiating with polarized light. After liquid crystal was sealed in a panel, the liquid crystal panel was heated at 130° C. for 40 minutes. Light irradiation with black light was carried out.

Experiment results: Alignment stability, particularly image sticking property could be improved without increasing driving voltage, lowering the contrast, and considerably lowering the voltage holding ratio.

The monomer is not limited thereto, and it is needless to say that the monomer in Example 2 can be also used. Further, a polymerization initiator may be added properly to promote polymerization.

Regarding effects of Examples 7 and 8 (suitability for narrow frame of liquid crystal panel)

A method for filling a panel with liquid crystal is generally carried out in such a manner that liquid crystal droplets are added dropwise to one substrate by a dispenser or the like and the other substrate is bonded thereto in vacuum.

In the bonding process, at the time of spreading the liquid crystal droplets in size, display unevenness may be caused in the case of employing a method for adding a monomer to liquid crystal because of the following possibility 1 and/or possibility 2.

Possibility 1: There is a possibility that the monomer concentration distribution is generated in the plane of a substrate because of an influence of adsorption dependency of a monomer to the substrate at the time of spreading liquid crystal droplets in size.

This concentration distribution leads to distribution of alignment regulating force of the liquid crystal, and thus display unevenness is caused.

Possibility 2: A sealing material is linearly formed in the circumference of a liquid crystal panel.

After bonding, when liquid crystal droplets contact with the sealing material before curing, un-cured sealing material components are dissolved in the liquid crystal to cause display failure.

Therefore, in general, before the liquid crystal droplets contact with the sealing material before curing, the sealing material is irradiated with ultraviolet rays to produce a state in which the sealing material is cured to a certain extent.

This makes it possible to prevent elution of the sealing components.

On the other hand, in order to sufficiently carry out curing, thermal curing by heating is carried out thereafter.

That is, it is general to select a material curable by both ultraviolet rays and heat as the sealing material.

However, a certain amount of ultraviolet rays inevitably leak to the inside of the seal part (display area) at the time of irradiation with ultraviolet rays for curing the seal.

If the leaked ultraviolet rays come in the monomer during the expansion of the liquid crystal droplets, polymerization of the monomer starts, resulting in a concern of display unevenness.

Therefore, a light shielding mask is applied so as not to allow ultraviolet rays to come in the display area with greatest care, but in the case of designing a panel with a narrow frame size by narrowing the width of a black matrix (BM), the seal part and the display area come close to each other, and thus it becomes impossible to completely avoid leakage of ultraviolet rays.

Consequently, this causes unevenness in the rim part of the display area.

Such a probability (concern) can be solved by adding a monomer to an alignment film material or applying a monomer to an alignment film surface, but not by adding a monomer to liquid crystal.

The reason for this is because the monomer is first eluted in liquid crystal by the heating step after the liquid crystal droplets are spread, no concentration gradation is generated and no monomer is dissolved in liquid crystal at the time of UV irradiation for curing seal.

In a case where the PS process is not carried out, in order to obtain sufficient alignment stability, it was necessary to increase rubbing strength such that the push-down amount of a pile of a rubbing cloth was set to 0.6 mm and the number of rubbing was set to 5 times, but in this case, uneven streaks by rubbing and foreign matter defects by the rubbing cloth or the peeled alignment film debris were often generated, and they were serious problems in terms of production. On the other hand, in a case where rubbing strength was made such that the push-down amount of a pile of a rubbing cloth was set to 0.5 mm and the number of rubbing was set to 3 times and no PS process was used, there occurred the problem that image sticking owing to insufficiency of alignment regulating force was considerably caused.

Use of a monomer with a polymerizable function as the monomer made it possible to produce a liquid crystal display device of a horizontal alignment mode excellent in image sticking properties at a high yield even by a rubbing alignment treatment.

As described in Example 5 and Example 6, use of polyimide including cyclobutane in the skeleton as the polymer main chain of the alignment film material is one of preferable embodiments of the present invention.

Use of the alignment film materials, monomers, and the like used in Examples 3 to 6 can similarly exert the advantageous effects even in the present invention.

The aforementioned modes of embodiments may be used in appropriate combination as long as the combination is not beyond the spirit of the present invention.

The present application claims priority to Patent Application No. 2011-177298 filed in Japan on Aug. 12, 2011 under the Paris Convention and provisions of national law in a designated State, the entire contents of which are hereby incorporated by reference.

### REFERENCE SIGN LIST

10, 10′, 110, 110′: array substrate
11, 21, 111, 111′, 121, 121′: transparent substrate
14a, 214a: pixel electrode
14b, 214b: common electrode
16, 26, 116, 116′, 126, 126′, 216, 226, 316, 326, 416, 426: photo-alignment film
17, 27, 117, 117′, 127, 127′: PS layer (polymer layer)
18, 118′: rear side polarizing plate
20, 120, 120′: color filter substrate
28, 128′: front side polarizing plate
30, 30′, 130, 130′, 230, 330, 430: liquid crystal layer
32, 32′, 532, 632: liquid crystal molecules
32p, 32p′: liquid crystal molecules having positive anisotropy of dielectric constant
32n, 32n′: liquid crystal molecules having negative anisotropy of dielectric constant
112, 112′: insulating film
114a, 114a′: combtooth electrode
114b′: planer electrode
333, 433: polymerizable monomer
333a, 433a: polymerizable monomer (non-excited)
333b, 433b: polymerizable monomer (excited state)
533, 633: polymerizable monomer
552: photoactive group (vertical alignment film molecules)
555: hydrophobic group
662: photoactive group (horizontal alignment film molecules)
CH: contact hole
D: drain electrode
G: scanning wiring
S: signal wiring
T: thin film transistor element

1. A liquid crystal display device comprising:
a liquid crystal cell that includes a pair of substrates and a liquid crystal layer which is interposed between the pair of substrates,
wherein at least one of the pair of substrates includes a photo-alignment film, and an electrode in the stated order from the liquid crystal layer side;
the photo-alignment film aligns liquid crystal molecules horizontally to the photo-alignment film surface;
the liquid crystal display device further includes a polarizing element in the observation surface side of the liquid crystal cell;
a polarization transmission axis direction of the polarizing element crosses an alignment direction of liquid crystal molecules at a voltage lower than the threshold voltage in the liquid crystal layer; and
a material constituting the photo-alignment film contains a material for aligning liquid crystal molecules in a direction crossing a polarization direction of polarized light irradiated to the photo-alignment film by polarized light irradiated to the photo-alignment film.

2. The liquid crystal display device according to claim 1,
wherein the polarization transmission axis direction of the polarizing element is perpendicular to the alignment direction of liquid crystal molecules at a voltage lower than the threshold voltage in the liquid crystal layer.

3. A liquid crystal display device comprising:
a liquid crystal cell that includes a pair of substrates and a liquid crystal layer which is interposed between the pair of substrates,
wherein at least one of the pair of substrates includes a photo-alignment film, and an electrode in the stated order from the liquid crystal layer side;
the photo-alignment film aligns liquid crystal molecules horizontally to the photo-alignment film surface;
the liquid crystal display device further includes a polarizing element in the observation surface side of the liquid crystal cell;
a polarization transmission axis direction of the polarizing element crosses an alignment direction of liquid crystal molecules at a voltage lower than the threshold voltage in the liquid crystal layer; and
a material constituting the photo-alignment film contains a polymer including a molecular structure represented by the following formula (1): 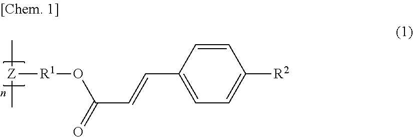
(in the formula, Z represents a polyvinyl monomer unit, a polyamic acid monomer unit, a polyamide monomer unit, a polyimide monomer unit, a polymaleimide monomer unit, or a polysiloxane monomer unit; R1 represents a single bond or a divalent organic group; R2 represents a hydrogen atom, a fluorine atom, or a monovalent organic group; and n represents an integer of 2 or greater.).

4. The liquid crystal display device according to claim 3,
wherein the monovalent organic group is an alkyl group, an alkoxy group, a benzyl group, a phenoxy group, a benzoyl group, a benzoate group, a benzoyloxy group or their derivatives.

5. The liquid crystal display device according to claim 1,
wherein the material constituting the photo-alignment film contains a material for aligning liquid crystal molecules in a direction perpendicular to the polarization direction of polarized light irradiated to the photo-alignment film by polarized light irradiated to the photo-alignment film.

6. A liquid crystal display device comprising:
a liquid crystal cell that includes a pair of substrates and a liquid crystal layer which is interposed between the pair of substrates,
wherein at least one of the pair of substrates includes a photo-alignment film, and an electrode in the stated order from the liquid crystal layer side;
the photo-alignment film aligns liquid crystal molecules horizontally to the photo-alignment film surface;
the liquid crystal display device further includes a polarizing element in the observation surface side of the liquid crystal cell;
a polarization transmission axis direction of the polarizing element is along an alignment direction of liquid crystal molecules at a voltage lower than the threshold voltage in the liquid crystal layer; and
a material constituting the photo-alignment film contains a material for aligning liquid crystal molecules in a direction along a polarization direction of polarized light irradiated to the photo-alignment film by polarized light irradiated to the photo-alignment film.

7. The liquid crystal display device according to claim 6,
wherein the polarization transmission axis direction of the polarizing element is parallel to the alignment direction of liquid crystal molecules at a voltage lower than the threshold voltage in the liquid crystal layer.

8. The liquid crystal display device according to claim 1,
wherein the photo-alignment film includes a photoisomerizable group and
the photoisomerizable group includes at least one kind selected from a group consisting of a cinnamate group, an azo group, a chalcone group, and a stilbene group.

9. (canceled)

10. The liquid crystal display device according to claim 6,
wherein the material constituting the photo-alignment film contains a material for aligning liquid crystal molecules in a direction parallel to the polarization direction of polarized light irradiated to the photo-alignment film by polarized light irradiated to the photo-alignment film.

11. The liquid crystal display device according to claim 1,
wherein at least one of the pair of substrates further includes a polymer layer in the liquid crystal layer side of the photo-alignment film.

12. The liquid crystal display device according to claim 1,
wherein a polymerizable functional group of the monomer includes at least one kind selected from a group consisting of an acrylate group, a methacrylate group, a vinyl group, a vinyloxy group, and an epoxy group.

13. The liquid crystal display device according to claim 1,
wherein the liquid crystal layer contains liquid crystal molecules including a multiple bond other than a conjugated double bond.

14. The liquid crystal display device according to claim 1,
wherein the polymer layer is a photopolymerized product.

15. The liquid crystal display device according to claim 1,
wherein an alignment mode of the liquid crystal layer is an IPS mode, an FFS mode, an FLC mode, or an AFLC mode.

16. The liquid crystal display device according to claim 3,
wherein the material constituting the photo-alignment film contains a material for aligning liquid crystal molecules in a direction perpendicular to the polarization direction of polarized light irradiated to the photo-alignment film by polarized light irradiated to the photo-alignment film.

17. The liquid crystal display device according to claim 3,
wherein at least one of the pair of substrates further includes a polymer layer in the liquid crystal layer side of the photo-alignment film.

18. The liquid crystal display device according to claim 3,
wherein a polymerizable functional group of the monomer includes at least one kind selected from a group consisting of an acrylate group, a methacrylate group, a vinyl group, a vinyloxy group, and an epoxy group.

19. The liquid crystal display device according to claim 3,
wherein the liquid crystal layer contains liquid crystal molecules including a multiple bond other than a conjugated double bond.

20. The liquid crystal display device according to claim 3,
wherein the polymer layer is a photopolymerized product.

21. The liquid crystal display device according to claim 3,
wherein an alignment mode of the liquid crystal layer is an IPS mode, an FFS mode, an FLC mode, or an AFLC mode.
